(19) United States
(12) Patent Application Publication
(10) Pub. No.: US 2014/0244790 A1
(43) Pub. Date: Aug. 28, 2014

(54) COMMUNICATION APPARATUS, COMMUNICATION METHOD AND NON-TRANSITORY COMPUTER READABLE MEDIUM

(71) Applicant: KABUSHIKI KAISHA TOSHIBA, Tokyo (JP)

(72) Inventors: Kotaro ISE, Kawasaki-Shi (JP); Takeshi ISHIHARA, Yokohama-Shi (JP)

(73) Assignee: KABUSHIKI KAISHA TOSHIBA, Tokyo (JP)

(21) Appl. No.: 14/187,735

(22) Filed: Feb. 24, 2014

(30) Foreign Application Priority Data
Feb. 27, 2013 (JP) 2013-037696

(51) Int. Cl. H04L 29/08

(52) U.S. Cl. CPC H04L 67/02
USPC 709/217

(57) ABSTRACT

According to an embodiment, there is provided a communication apparatus including: a first acquiring unit, a determining unit and a second acquiring unit. The first acquiring unit acquires first data from a first acquisition destination upon receiving an acquisition request of the first data from a requester. The determining unit determines second data required for the requester by analyzing the first data acquired by the first acquiring unit and then determines whether the second data exists in a data storage accessible from the requester, the data storage being arranged inside or outside the communication apparatus. The second acquiring unit acquires the second data from a second acquisition destination when it is determined the second data does not exist in the data storage.

### CROSS REFERENCE TO RELATED APPLICATIONS

This application is based upon and claims the benefit of priority from the prior Japanese Patent Application No. 2013-037696 filed on Feb. 27, 2013, the entire contents of which are incorporated herein by reference.

### FIELD

Embodiments described herein relates to a communication apparatus, a communication method and a communication program.

### BACKGROUND

Over the recent years, there has been an outstanding spread of network technologies typified by Web technologies, in which a variety of equipment (which will hereinafter be called terminals) such as personal computers, mobile phones, smartphones, TVs, Blu-ray recorders and printers are connected to networks. The terminal acquires data from apparatuses (which will hereinafter be called servers) on the network and processes the data. For example, the terminal, if including a Web browser, acquires HTML data from the server by use of HTTP (HyperText Transfer Protocol) protocol, and displays the acquired HTML data or executes a JavaScript (registered trademark) program contained in the HTML data. A system mode known as so-called cloud computing comes out, in which the server is, if having high performance, made to execute a part or a majority of processes that are to be performed by the terminal, and the terminal receives processing results thereof.

A proxy technology is known in terms of load balancing of the server and the load balancing of the network on such an occasion that the terminal thus acquires the data from the server. In the case of using the proxy technology, the terminal transmits a data acquisition request for the server to the proxy (proxy server), and the proxy, if already stored with the requested data, transmits this stored data to the terminal. The proxy, whereas if not stored with the requested data, transmits the data acquisition request to the server. Then, the proxy transmits the data acquired from the server to the terminal and also stores the acquired data therein. A quantity of the data acquisition requests received by the server is decreased by use of the proxy, and hence the terminal can reduce a period of time expended for acquiring the data.

A pre-fetch proxy technology can be given by way of a modified example of the proxy technology. In this pre-fetch proxy technology, a pre-fetch proxy, before receiving the data acquisition request from the terminal, acquires the data by transmitting the data acquisition request to the server, and retains this data. On the occasion of transmitting the data acquisition request, the pre-fetch proxy does not know which data the terminal will acquire in the future. Therefore, the pre-fetch proxy makes some sort of inference and determines the data to be acquired. For example, such a method is known as to pre-acquire, when the terminal requests the pre-fetch proxy for a certain item of HTML data, an object (reference object) that is referred to from this HTML data. The objects, which have already been retained by the pre-fetch proxy, are recorded in a referrer-to-reference corresponding table, and, on the occasion of acquiring the reference objects, the objects registered in this table are unnecessary to be acquired.

Considered herein is an operation of the terminal having an access to the pre-fetch proxy. The terminal caches the data that has been acquired once. The terminal, on the occasion of acquiring a certain item of HTML data, consecutively tries to acquire the reference data that is referred to from this HTML data. The terminal, on the occasion of acquiring these items of reference data, checks whether or not these reference objects exist in a self-retained cache. If the data exist in the cache, the terminal makes use of the data retained by the terminal itself without transmitting the data acquisition request to the pre-fetch proxy.

However, in the method of using the referrer-to-reference corresponding table described above, the pre-fetch proxy acquires (pre-fetches) even the object retained in the cache of the terminal from the server as the case may be. The terminal does not transmit the data acquisition request for this object, and hence such a problem arises that power consumption of the pre-fetch proxy resultantly increases.

### BRIEF DESCRIPTION OF THE DRAWINGS

FIG. 1 is a view illustrating architecture of a whole communication system according to a first embodiment;

FIG. 2 is a diagram illustrating a configuration of a communication terminal mounted with a communication apparatus according to the first embodiment;

FIG. 3 is a diagram illustrating a concept of a data structure for managing storage data information;

FIG. 4 is a flowchart illustrating an operation flow of a data acquiring unit;

FIG. 5 is a flowchart illustrating another operation flow of the data acquiring unit;

FIG. 6 is a flowchart illustrating an operation flow of a data pre-acquiring unit;

FIGS. 7A and 7B are a diagram illustrating an operation sequence in a terminal;

FIG. 8 is a diagram illustrating an example of a hardware configuration of the terminal according to the first embodiment;

FIG. 9 is a diagram illustrating an example of a configuration of the terminal mounted with the communication apparatus according to a second embodiment;

FIGS. 10A and 10B are a diagram illustrating an operation sequence of the terminal according to the second embodiment;

FIG. 11 is a view illustrating architecture of a whole communication system according to a third embodiment;

FIG. 12 is a diagram illustrating an example of a configuration of the terminal according to the third embodiment;

FIG. 13 is a diagram illustrating an example of a configuration of a pre-fetch proxy mounted with the communication apparatus according to the third embodiment;

FIG. 14 is a diagram illustrating an example 1 of a hardware configuration of the terminal according to a fourth embodiment;

FIG. 15 is a diagram illustrating an example 2 of the hardware configuration of the terminal according to the fourth embodiment;

FIG. 16 is a diagram illustrating an example 3 of the hardware configuration of the terminal according to the fourth embodiment;

FIG. 17 is a diagram illustrating an example 4 of the hardware configuration of the terminal according to the fourth embodiment;

FIG. 18 is a diagram illustrating an example 5 of the hardware configuration of the terminal according to the fourth embodiment;

FIG. 19 is a diagram illustrating an example 6 of the hardware configuration of the terminal according to the fourth embodiment; and

FIG. 20 is a diagram illustrating an example 7 of the hardware configuration of the terminal according to the fourth embodiment.

### DETAILED DESCRIPTION

According to an embodiment, there is provided a communication apparatus including: a first acquiring unit, a determining unit and a second acquiring unit.

The first acquiring unit acquires first data from a first acquisition destination upon receiving an acquisition request of the first data from a requester.

The determining unit determines second data required for the requester by analyzing the first data acquired by the first acquiring unit and then determines whether the second data exists in a data storage accessible from the requester, the data storage being arranged inside or outside the communication apparatus.

The second acquiring unit acquires the second data from a second acquisition destination when it is determined the second data does not exist in the data storage.

Hereinafter, embodiments will be described with reference to the accompanying drawings.

In terminologies of Web technologies, what (link element) is identified by URL (Uniform Resource Locator) is called an “object”. In the case of the object described by languages such as HTML (HyperText Markup Language) and XML (Extensible Markup Language), another “object” can be referred to by describing an URL within a tag set. For example, according to the HTML, the URL is described as a “href” (hyperlink reference) attribute within an <a> tag set (<a href=“url”> . . . </a>). Similarly, it is possible to refer to other objects by describing URLs within a <script> tag set, an <image> tag (no closing tag), a <frame> tag (no closing tag) and a <link> tag (no closing tag). Thus, a certain object, which is referred to by the object described in the HTML, is called a “reference object”, and conversely the object referring to the reference object is called a “referrer object” (referrer object-refers->reference object). The object can contain zero or more reference objects and can also has zero or more referrer objects.

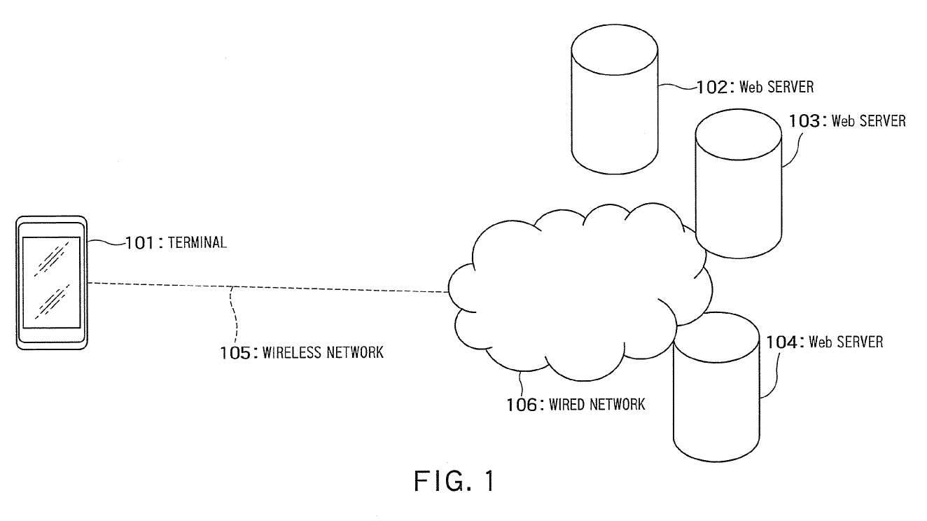

FIG. 1 is a view illustrating architecture of a whole communication system according to the first embodiment. In FIG. 1, a terminal 101 is enabled to perform communications with Web servers 102, 103, 104 via a wireless network 105 and a wired network 106. The terminal 101 is exemplified by, e.g., a smartphone, a mobile phone, a tablet PC, a notebook PC, a small-sized browser terminal and an e-book terminal. The Web servers 102-104 are servers that execute software such as Apache (Web server software) and perform HTTP (HyperText Transfer Protocol)-based communications with the terminal. Each of the Web servers 102-104 retains data and serves as a destination from which the terminal acquires the data. The wireless network 105 is a communication network conforming to a communication method based on IEEE802.11 Standards, a cellular communication method such as LTE (Long Term Evolution) and a WiMax communication method. The wired network 106 is a communication network built up by, e.g., optical fibers.

The terminal 101 transmits a data acquisition request to the Web server. The data acquisition request contains the URL written as an object identifier. The Web server transmits, to the terminal, an object associated with the object identifier contained in the received data acquisition request by way of a data acquisition response. The terminal analyzes the received object, and if the received object refers to other objects specified by, e.g., the <script> tags, the <image> tag, the <frame> tag and the <link> tag, transmits the data acquisition requests for the data about these objects to the Web servers. It is a matter of course that the data acquisition requests at this time are transmitted to the Web servers specified by the object identifiers thereof.

The terminal, after acquiring a certain object, obtains all elements needed for displaying a window in the reference object of the acquired object, and displays the window on the basis of these objects. Herein, it is desirable not to acquire the reference object which is not immediately required. For example, as in the case of the reference object specified by the <a> tags, this type of reference object is applicable to the object that may be acquired by clicking the relevant portion (URL) with a mouse after displaying the window. Displaying the window involves using, e.g., Web Browsers preinstalled on the terminal. Note that the Web server from which the object is acquired first is the same as but also different from the Web server from which the reference object is acquired thereafter as the case may. Namely, a first acquisition destination defined as the destination from which to acquire first data is the same as but also different from a second acquisition destination defined as the destination from which to acquire second data as the case may be.

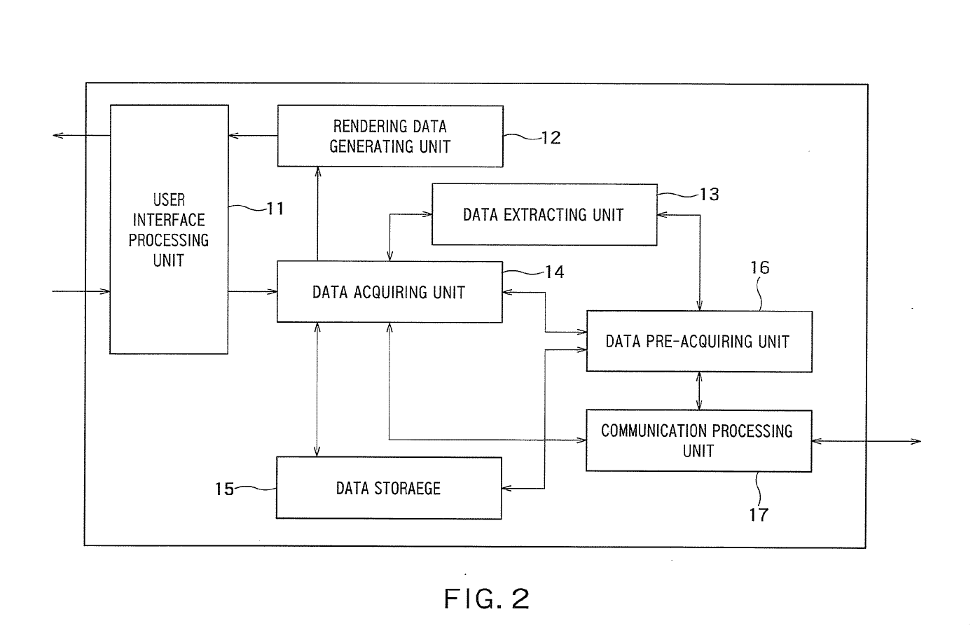

FIG. 2 is a diagram illustrating a configuration of a communication terminal mounted with a communication apparatus according to the first embodiment. The communication terminal (which will hereinafter be simply termed the terminal) depicted in FIG. 2 includes a user interface processing unit 11, a rendering data generating unit 12, a data extracting unit 13, a data acquiring unit 14, a data storage 15, a data pre-acquiring unit (a first acquiring unit, a determining unit, a second acquiring unit) 16 and a communication processing unit 17.

(User Interface Processing Unit 11)

The user interface processing unit 11 receives rendering data from the rendering data generating unit 12 and displays a window based on this rendering data. Further, the user interface processing unit 11, when receiving an operation such as a mouse click and if this mouse operation is an operation of making a request for acquiring the data as in the case of selecting a link on the window, sends the URL thereof to the data acquiring unit 14.

(Rendering Data Generating Unit 12)

The rendering data generating unit 12 receives object data from the data acquiring unit 14, then generates the rendering data based on the object data, and transmits the rendering data to the user interface processing unit 11. Herein, the “object data” are exemplified by, e.g., HTML data, image data and CSS (Cascading Style Sheets) data.

(Data Extracting Unit 13)

The data extracting unit 13 receives the object data from the data acquiring unit 14 or the data pre-acquiring unit 16, then extracts the URL of the reference object contained therein by analyzing the object data, and sends the extracted URL back to the data acquiring unit 14 or the data pre-acquiring unit 16.

(Data Acquiring Unit 14)

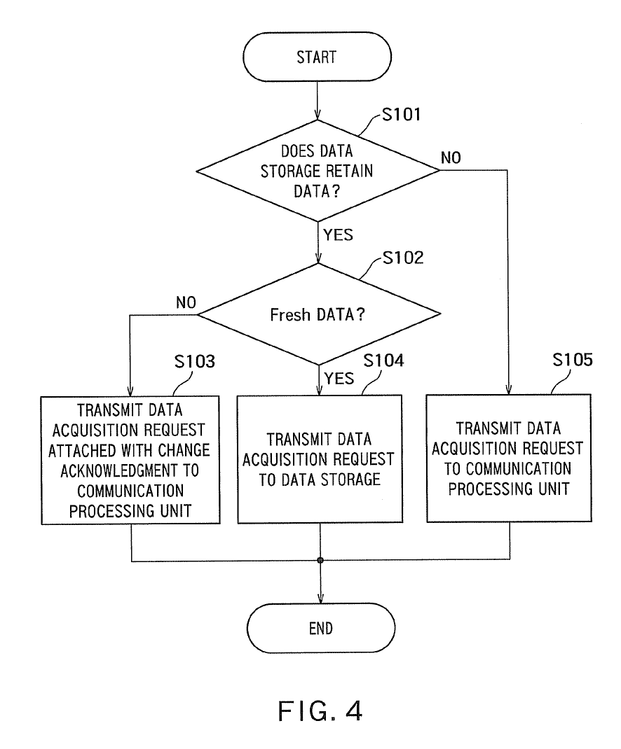

The data acquiring unit 14, when obtaining the URL used for the request for acquiring the data from the user interface processing unit 11, acquires the data associated with this URL. FIG. 4 shows an operating flow of this acquisition.

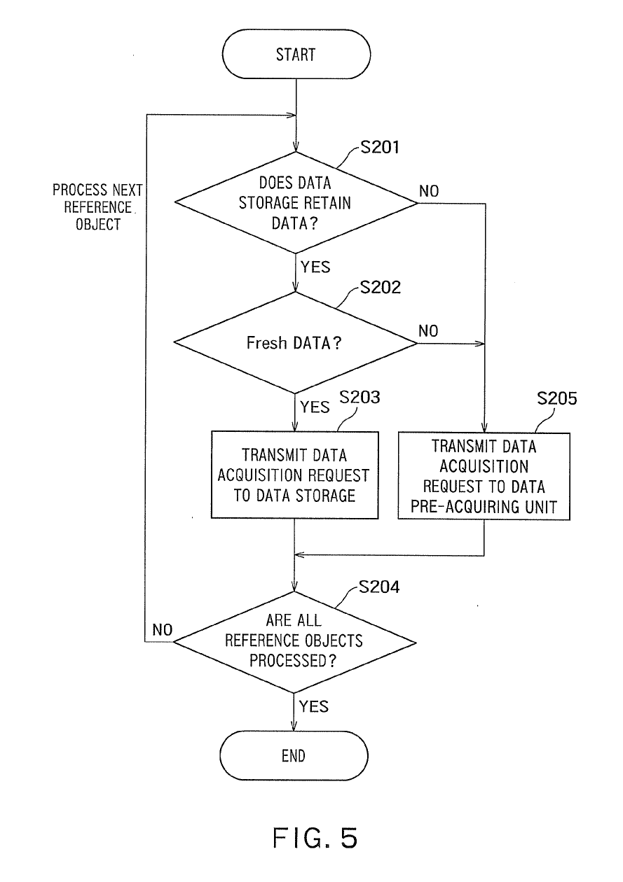

To start with, the data acquiring unit 14 checks whether the data storage 15 retains the data of the URL or not (S101). If the data storage 15 retains “Fresh” data (YES in S101, YES in S102), the data acquiring unit 14 acquires the data from the data storage 15 (S104). Whereas if not fresh, i.e., though the data storage 15 retains the data, if the data is in a “Stale” status (NO in S102), the data acquiring unit 14 transmits a data acquisition request attached with change acknowledgement to the Web server via the communication processing unit 17 and thus receives the data from the Web server (S103). If the data storage 15 does not retain the data of the URL (NO in S101), the data acquiring unit 14 transmits the data acquisition request via the communication processing unit 17, and receives the data from the Web server (S105). The data acquiring unit 14 hands the data acquired from the Web server or the data storage 15 over to the data extracting unit 13, and receives the reference object contained in this data from the data extracting unit 13. Then, the data acquiring unit 14 performs a data acquiring operation with respect to the reference object. FIG. 5 illustrates a flow of this acquiring operation.

At first, the data acquiring unit 14 checks whether or not the data storage 15 retains the data of the reference object (S201). If the data storage 15 retains the fresh data (YES in S201, YES in S202), the data acquiring unit 14 acquires the data from the data storage 15 (S203). Whereas if the data storage 15 does not retain the fresh data (NO in S201) or if retaining the stale data (NO in S202), the data acquiring unit 14 requests the data pre-acquiring unit 16 to acquire the reference object (S205), and acquires the data associated with this reference object from the data pre-acquiring unit 16. The processes described above are executed with respect to all of the reference objects (S204).

The data of the referrer object and the data of the reference object, which have been obtained by the operations in FIGS. 4 and 5, are handed over to the rendering data generating unit 12 and to the data storage 15.

(Data Storage 15)

The data storage 15 is a storage that is accessible (readable/writable) from the data acquiring unit 14. The data storage 15, upon receiving the data from the data acquiring unit 14, stores the received data in an internal portion thereof. Further, the data storage 15, in the case of receiving a query about whether the data of a certain URL are retained or not, sends any one of the following three responses back to the data acquiring unit 14. These responses are:

Fresh data are retained;

Stale data are retained; and

Data are not retained.

Moreover, the data storage 15, in the case of receiving the data acquisition request with respect to a certain URL from the data acquiring unit 14, extracts the data associated with this URL from the internal portion, and sends the extracted data back to the data acquiring unit 14. The data storage 15 performs the same procedures as those with the data acquiring unit also with respect to the data pre-acquiring unit 16.

In the case of receiving a delete event via the user interface processing unit 11, it is desirable for the data storage 15 to have a function to delete the stored data. Further, if a free space of a data storage area decreases, it is desirable to delete a part of the data to be stored. On this occasion, a variety of available methods for selecting which items of data are deleted can be exemplified such as a method of deleting the data from those acquired at the earlier date/time and a method of deleting the data from those accessed at the earlier time.

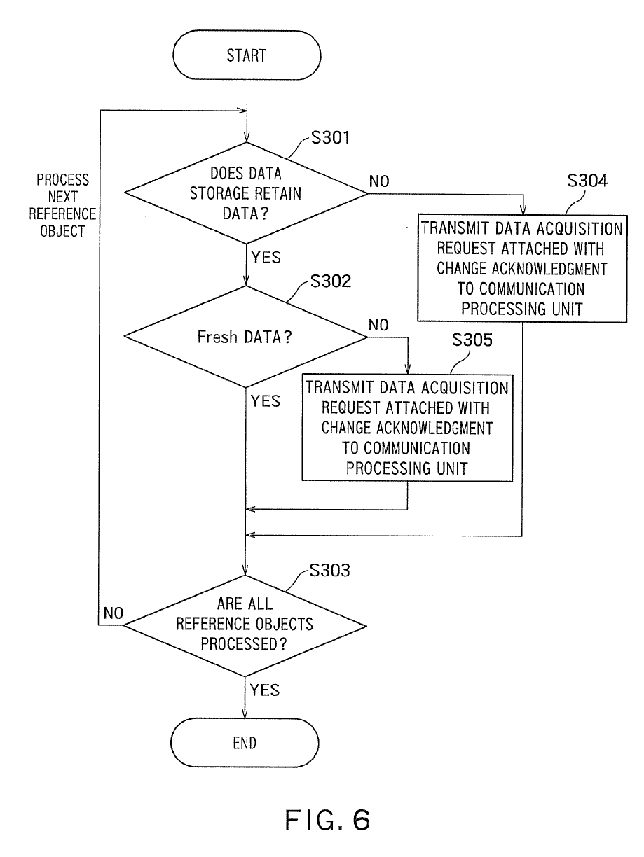

The data pre-acquiring unit 16, when receiving the object data from the communication processing unit 17, sends the received object data to the data extracting unit 13 and receives the URLs of the reference objects from the data extracting unit 13. The data pre-acquiring unit 16 queries the data storage 15 about a retaining status of how the data storage 15 retains data associated with each URL, and thus acquires the data. FIG. 6 illustrates an operating flow of the data acquisition.

If the fresh data are stored in the data storage 15 (i.e., the data exists in the data storage 15) (YES in S301, YES in S302), acquisition operation on the data is not carried out. If the stale data are stored (i.e., the data exists in the data storage 15) in the data storage 15 (NO in S302), the data pre-acquiring unit 16 transmits the acquisition request attached with the change acknowledgment to the Web server via the communication processing unit 17, and receives the data as a response thereto (S305). Whereas if the data are not stored in the data storage 15 (i.e., the data does not exists in the data storage 15), the data pre-acquiring unit 16 transmits the acquisition request to the Web server via the communication processing unit 17 (S304), and receives the data as a response thereto. The data pre-acquiring unit 16 sends the data received from the Web server to the data acquiring unit 14.

(Communication Processing Unit 17)

The communication processing unit 17 executes communication processes needed between the data acquiring unit 14 or the data pre-acquiring unit 16 and the Web server. To be specific, the communication processing unit 17 executes protocol processing of TCP (Transmission Control Protocol), protocol processing of IP (Internet Protocol), protocol processing for wireless communications and signal processing.

Next, an in-depth description of an operation of the data storage 15 will be made. The data storage 15 gets stored with items of information such as {data body, URL, data generation date/time, etag, age, max-age, data acquisition date/time} with respect to the data of the individual objects. It is desirable that the data storage 15 can search for storage data information with the URL being used as a search key in order to make an efficient response to a query given from the data acquiring unit 14 or the data pre-acquiring unit 16. For attaining this capability, it is desirable to include a data structure with the URL being used as hash key. Respective elements contained in the storage data information will be described.
The data body is defined as the object data, i.e., the data that are acquired based on the HTTP, such as HTML data, image data and JavaScript data.
The URL is defined as identification information for identifying the object.
The data generation date/time is defined as the date/time that is counted (time-stamped) when the server generates the object data. The data generation date/time is written in a DATE header of the HTTP on the occasion of acquiring the data and thus sent from the server to the terminal. It is desirable for the data generation date/time to be counted not by a timer of the terminal but by a timer of the server.
“etag” is defined as an identifier allocated to the object by the server. It is also desirable for a value of this identifier to be changed each time a content of the object is changed. This identifier is written in an Etag header of the HTTP on the occasion of acquiring the data and thus sent to the terminal from the server.
“age” is defined as an elapsed period of time since the object has been generated. This time value is written in an Age header of the HTTP and thus sent to the terminal from the server.
“max-age” is defined as a period of time for which the object is set in the Stale status if a period of time described in “max-age” elapses since the object has been generated. This time value is written in a Cache-Control header of the HTTP and thus sent to the terminal from the server.
“Data acquisition date/time” is defined as a date/time when the terminal acquires the object data. It is desirable that this time value is a value counted by the timer of the terminal.

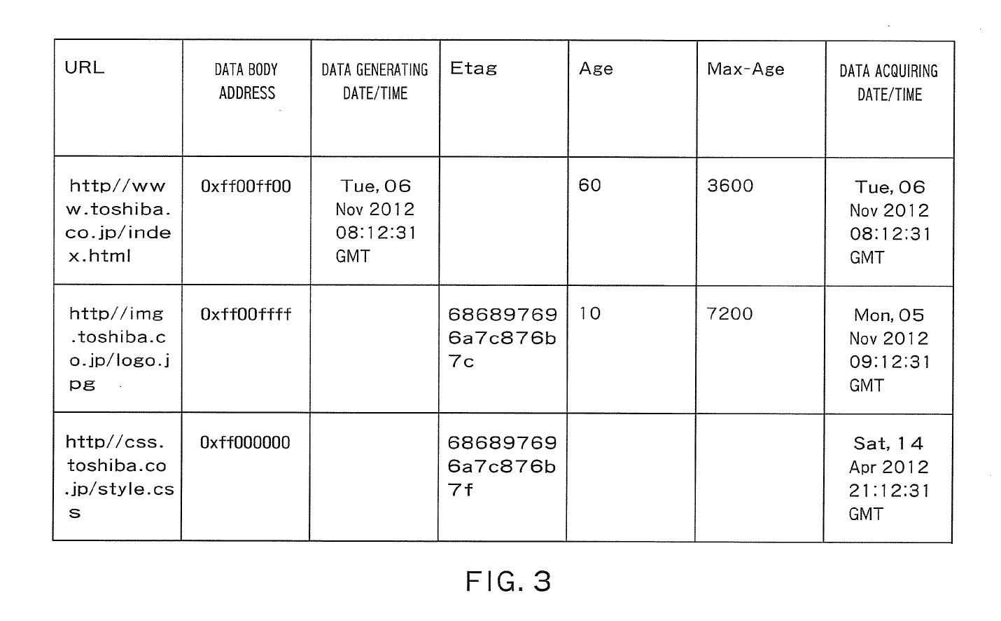

FIG. 3 is a diagram illustrating a concept of the data structure for managing the storage data information. In FIG. 3, the data body is stored as a file, and a fast access to the data body is attained by referring to an address of a file pointer of the data body. A unit value of time of each of “age” and “max-age” is “second”.

The data storage 15, when receiving the URL in response to the query about whether the data are retained or not, at first searches the Table in FIG. 3, and determines whether the relevant data are retained or not. A variety of techniques for speeding up the search such as a tree structure and a hash structure with the URL being used as the search key, can be applied to this Table search.

In the case of retaining the data, the data are determined to be “Fresh” if the following formula is established but to be “Stale” whereas if not. Note that a symbol “−” notates a minus calculation.

Present Date/Time−Data Acquisition Date/Time<“Max-Age”−Age

Further, if no value is entered in at least any one of “max-age” and “age” as in a third entry in FIG. 3, it is determined from the following formula whether the data are “Fresh” or “Stale” (“a” is a predetermined threshold value).

Present Date/Time−Data Acquisition Date/Time<α

It can be considered that a Fresh-or-Stale determining method is modified in a variety of forms. For example, the following formula can be used. Herein, “β” is a predetermined threshold value.

Present Date/Time−Data Acquisition Date/Time<“Max-Age”−Age−β

Further, “β” can take a value that differs depending on types of the data such as the HTML data, the CSS data and the JavaScript data. It is desirable that the type of the data is known from an identifier contained in a Content-Type header of the HTTP on the occasion of acquiring the data. Moreover, a value, which differs depending on the server acquiring the data, can be used as the value of “β”.

Given next are descriptions of the data acquisition request and the data acquisition data attached with the change acknowledgment that are sent to the communication processing unit 17 by the data acquiring unit 14 or the data pre-acquiring unit 16.

The data acquisition request contains, e.g., the following information:

HTTP GET www.toshiba.co.jp/index.html

The communication processing unit 17, when receiving this data acquisition request, queries a DNS (Domain Name System) server about a domain name (FQDN; Fully Qualified Domain Name) www.toshiba.co.jp, and acquires an IP address associated with this domain name. Then, the communication processing unit 17 establishes a TCP connection of a destination port number 80, and transmits an HTTP request containing the following GET command toward this IP address:

GET www.toshiba.co.jp/index.html HTTP/1.1

The communication processing unit 17 receives the following HTTP response by way of a response to the request from the Web server receiving this request. However, a description of the data body is omitted.

HTTP/1.1 200 OK

Content-Length:16231

Content-Type:text/html

Date:Mon, 5 Nov. 2012 09:10:23 GMT

ETag:“3f67-4cdb3d974e780”

Age:520910

Cache-Control: public, max-age=1209600

In the response described above, a number 200 implies that the server transmits the data in a first line. Further, “16231” in the line of “Content-Length” indicates a byte count of the data. In the line of “Content-Type”, “text/html” represents the HTML data. The data generation/date/time is given in the line of “Date”. A value of ETag is given in the line of “ETag”. The line of “Age” indicates the elapsed time since a point of time when the data has been generated. In the line of “Cache-Control”, “max-age” represents the maximum elapsed time when the data are deemed to be Fresh.

The data acquisition request attached with the change acknowledgment involves two types of methods, i.e., a method of using Etag and a method of using the data generation date/time.

To begin with, in the case of using the data generation date/time, the data acquiring unit 14 or the data pre-acquiring unit 16 sends the data acquisition request attached with a change condition containing the following GET command and date/time data to the communication processing unit 17.

GET www.toshiba.co.jp/index.html HTTP/1.1

If-Modified-Since: Tue, 6 Nov. 2012 08:12:31 GMT

The communication processing unit 17, in the same way as in the case of receiving the data acquisition request, queries the DNS server about an IP address associated with www.toshiba.co.jp, thereafter sets up a TCP connection of the destination number 80 and transmits the HTTP request toward the obtained IP address. The Web server receiving this HTTP request, if the data of the requested URL has no change (Not Modified) from the date/time described in the line of “If-Modified-Since”, give a response purporting that there is no change. If there is the change, the Web server transmits the same response as in the case of receiving the data acquisition request. The following is an example of the response purporting that there is no change (Not Modified). In this case, the Web server does not transmit the data body.

HTTP/1.1 304 Not Modified

On the other hand, in the case of transmitting the data acquisition request attached with the change acknowledgment by use of Etag, the data acquiring unit 14 or the data pre-acquiring unit 16 transmits a request containing the following GET command and Etag data to the Web server.

GET www.toshiba.co.jp/index.html HTTP/1.1

If-None-Match: “686897696a7c876b7e”

The Web server receiving this request checks whether or not the data of the requested URL has an identifier different from the identifier given in the line of “If-None-Match”, and, if having no change (the same identifier is contained) gives a response purporting that there is no change (Not Modified). If there is the change, the Web server transmits the same response as in the case of receiving the data acquisition request. The following is an example of the response with the purport of there being no change. In this case, the Web server does not transmit the data body.

HTTP/1.1 304 Not Modified

The description given above has dealt with the case in which the data acquisition request attached with the change acknowledgment involves any one of the method of using Etag and the method of using the data generation date/time, but both of these methods can be employed. In this case, the Web server selects and employs, on the occasion of making the change acknowledgment, the preferable of the two methods, i.e., the Etag using method and the data generation date/time using method.

(Sequence of Terminal)

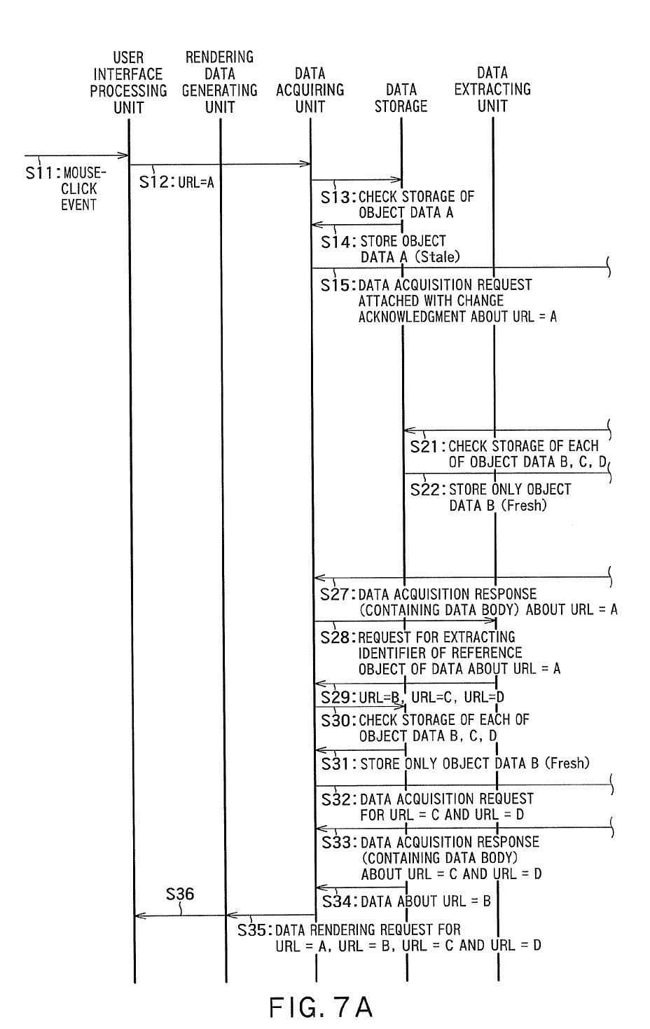

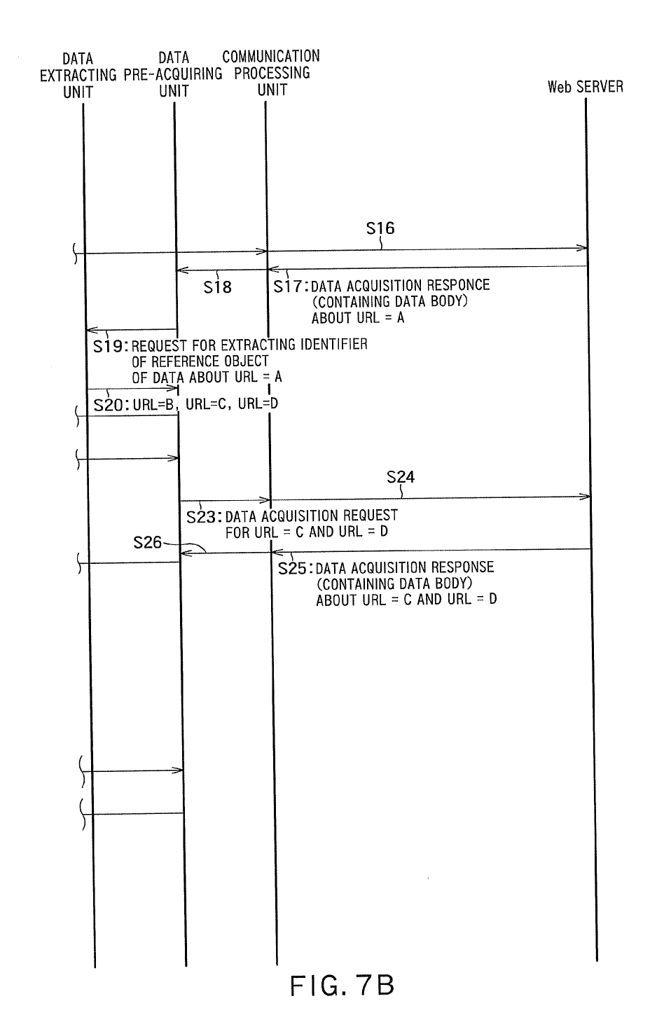

FIGS. 7A and 7B illustrates an example of an operation sequence of the terminal.

This operation example is given in the case of acquiring the data of URL=A (e.g., HTTP://www.toshiba.co.jp/index.html) upon a mouse-click event on the assumption that the identifiers of the reference objects of URL=A (the referrer object) are URL=B, URL=C and URL=D. Furthermore, it is also assumed that the data storage 15 has got already stored with URL=B in the Fresh status.

The mouse-click event is inputted to the user interface processing unit 11 (S11), and URL=A is sent to the data acquiring unit 14 (S12). The data acquiring unit 14 checks whether the data of URL=A is retained on the data storage 15 or not (S13), and acquires a response indicating that the data in the Stale status is retained (S14). The data acquiring unit 14 transmits the data acquisition request attached with the change acknowledgment with respect to URL=A to the Web server via the communication processing unit 17 (S15, S16). A data acquisition response (containing the data body) with respect to URL=A is sent back from the Web server and handed over to the data pre-acquiring unit 16 via the communication processing unit 17 (S17, S18).

The data pre-acquiring unit 16 requests the data extracting unit 13 to extract the identifiers of the reference objects of the data with respect to URL=A, with the result that the identifiers of URL=B, URL=C and URL=D are sent back (S19, S20). The data pre-acquiring unit 16 queries the data storage 15 about whether the data storage 15 retains the data of URL=B, URL=C and URL=D (S21). The data pre-acquiring unit 16 obtains a response indicating that the data storage 15 is stored with the Fresh data of URL=B but is stored with none of such data of URL=C and URL=D (S22). The data pre-acquiring unit 16 transmits the data acquisition requests for URL=C and URL=D to the Web servers via the communication processing unit 17 (S23, S24). Data acquisition responses (containing the data bodies) with respect to URL=C and URL=D are sent back from the Web servers and handed over to the data pre-acquiring unit 16 via the communication processing unit 17 (S25, S26).

The data pre-acquiring unit 16 sends a data acquisition response (containing the data body) with respect to URL=A to the data acquiring unit 14 (S27). The data acquiring unit 14 requests the data extracting unit 13 to extract the identifiers of the reference objects of the data with respect to URL=A (S28). The data extracting unit 13 extracts the identifiers of URL=B, URL=C and URL=D and sends the identifiers back to the data acquiring unit 14 (S29). The data acquiring unit 14 queries the data storage 15 about whether or not the data storage 15 retains the data of URL=B, URL=C and URL=D (S30). The data acquiring unit 14 obtains a response indicating that the data storage 15 is stored with the Fresh data with respect to URL=B but is stored with none of such data with respect to URL=C and URL=D (S31). The data acquiring unit 14 sends the data acquisition requests for URL=C and URL=D to the data pre-acquiring unit 16 (S32). The data pre-acquiring unit 16 sends the data acquisition responses (containing the data bodies) with respect to URL=C and URL=D acquired in step S26 back to the data acquiring unit 14 (S33). Further, the data acquiring unit 14 acquires the data of URL=B from the data storage 15 (S34). The data acquiring unit 14 sends a rendering request of the data with respect to URL=A, URL=B, URL=C and URL=D to the rendering data generating unit 12 (S35). The rendering data generating unit 12 renders the data with respect to URL=A, URL=B, URL=C and URL=D, and hands the rendered data over to the user interface processing unit 11 (S36).

In the sequence of FIG. 7, it is supposed that the data storage 15 is stored with the object data of URL=C in the Stale status in step S22. In this case, it is desirable that the data pre-acquiring unit 16 transmits the data acquisition request attached with the change acknowledgment with respect to the object of URL=C to the Web server via the communication processing unit 17. In the case of receiving the data body as a response thereto from the Web server, it is desirable to send this data body to the data acquiring unit 14. In the case of receiving a response purporting that there is no change from the Web server, it is desirable that this purport is notified to the data acquiring unit 14. It is also desirable that the data acquiring unit 14 receiving the notification with the purport of there being no change acquires the data about the object of URL=C not from the data pre-acquiring unit 16 but from the data storage 15.

It is desirable that the data storage 15 gets stored with the data received by the data pre-acquiring unit 16 from the Web server (refer to steps S17, S25). A mode of attaining this request can be exemplified by a variety of methods such as a method by which the data pre-acquiring unit 16 requests the data storage 15 to retain the data or a method by which the data acquiring unit 14 receiving the data from the data pre-acquiring unit 16 requests the data storage 15 to retain the data.

In FIG. 7, the data pre-acquiring unit 16, after acquiring the data of both of URL=C and URL=D in step S26, sends the data of URL=A to the data acquiring unit 14 in step S27, but there exist multiple variations in timing of transmitting the data of URL=A.

For example, the data acquiring unit 14, after transmitting the data acquisition request for URL=A (refer to step S15), may send the data of URL=A (i.e., the referrer object) to the data acquiring unit 14 from the data pre-acquiring unit 16 as triggered by such a time event that the predetermined period of time has elapsed. This contrivance enables a start of rendering the data of URL=A even when it is time-consuming to acquire the reference object, whereby a user's irritating feeling caused by waiting for the rendering can be moderated.

Moreover, by way of another example, a degree of importance of the reference object is determined based on a type of the data of the reference object, and, at a point of time when finishing acquiring the reference object exhibiting a fixed degree or higher degree of importance, the data of URL=A may also be transmitted. For instance, there are the CSS data, the image data and the JavaScript data as the reference objects, in which case the data of URL=A may be transmitted at a point of time when finishing receiving the CSS data. The HTML data and the CSS data of URL=A are transmitted to the data acquiring unit in advance of acquiring the image data and the JavaScript data, thereby enabling the rendering data generating unit to start processing without waiting for the time-consuming acquisition of the data such as especially the image data. This results in an advantage that the user can confirm rough contents of the window at an early stage.

At this time, the data type can be inferred from the URL. For example, the data type can be inferred to be the CSS data if the URL ends with an identifier such as “.css” and to be the JavaScript data if ending with “.js”.

Furthermore, it is possible to infer the data type from a context describing the reference objects within URL=A (i.e., the referrer object). For instance, it can be inferred that the reference object described in the <link> tag is a CSS file, and the reference object given within the <script> tags is script data. Alternatively, the data type can be inferred from a type attribute of the reference object. For example, if the referrer object contains a description such as <script type=“text/javascript” src=“/javascript/fp.js”></script>, it can be inferred from “text/javascript” defined as the type attribute that the reference object (/javascript/fp.js) is JavaScript data.

According to the first embodiment, the data pre-acquiring unit 16 does not pre-acquire the data stored in the data storage 15, and hence a reduction in power consumption can be realized.

The discussion on the first embodiment has been done by exemplifying the terminal preinstalled with the Web browser, but terminals taking other modes are also available. For example, such a terminal is also available as to acquire sound data of music etc. from other apparatuses via a communication network and output the sound through a loudspeaker. At this time, the terminal may acquire the data by receiving a user's instruction without via a window, such as inputting the voice/sound.

Moreover, though the discussion has been done by exemplifying the case of using the URL as the object identifier (the identification information of the data), a variety of elements such as UUID (Universally Unique Identifier) other than the URL can be applied to the object identifier.

(Hardware Configuration)

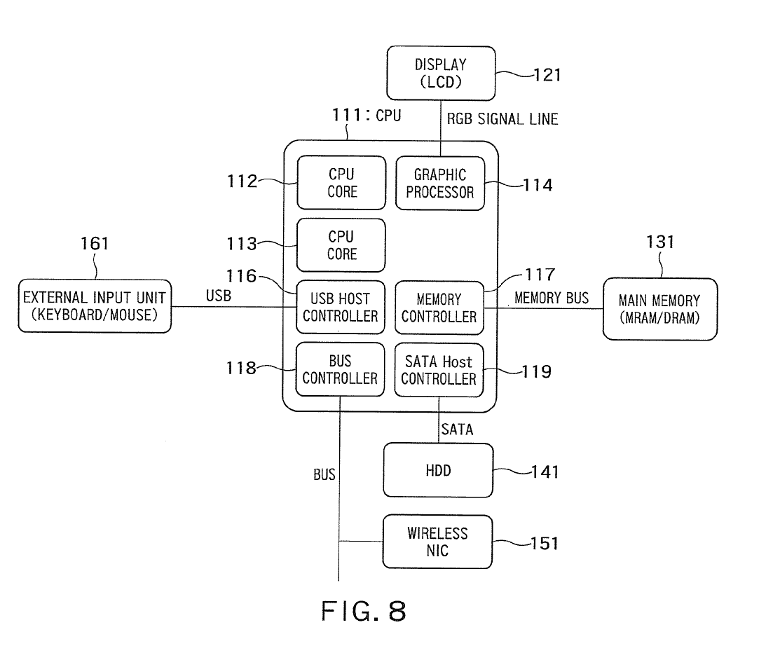

FIG. 8 illustrates an example of a hardware configuration of the terminal according to the first embodiment.

The terminal includes a CPU 111, a display 121 (e.g., an LCD (Liquid Crystal Display), a main memory 131, a HDD 141, a wireless NIC (Network Interface Card) 151 and an external input unit 161 (a keyboard, a mouse, etc.). The CPU 111 includes one or more CPU cores 112, 113, a graphic processor 114, a USB host controller 116, a memory controller 117, a bus controller 118 and a SATA (Serial Advanced Technology Attachment) host controller 119.

The CPU cores 112, 113 perform arithmetic operations based on an executive command.

The graphic processor 114 generates, based on a rendering command given from the CPU core, RGB (Red, Green, Blue) signals and outputs the RGB signals to the display 121.

The USB host controller 116 transmits and receives information to and from USB devices based on USB (Universal Serial Bus) Standards.

The bus controller 118 transmits and receives the data to and from devices on the bus according to bus standards such as PCI-Express (Peripheral Component Interconnect Express).

The SATA host controller 119 transmits and receives the data to and from the device (HDD 141) via a SATA cable according to SATA (Serial Advanced Technology Attachment) Standards.

The display 121 displays the signals inputted as the RGB signals converted into a man-readable format.

The main memory 131 is a memory device exemplified such as DRAM (Dynamic Random Access Memory). The main memory 131 is connected to the CPU 121 through, e.g., an interface (memory bus) called DDR3 (Double-Data-Rate3). The memory controller 117 reads and writes the data in the main memory 131.

The HDD 141 is a device stored with digital information of a magnetic medium as by, e.g., “MK1059GSM” of TOSHIBA CORPORATION. The HDD 141 is connected to the CPU 111 via the SATA interface. Any inconvenience may not be caused by using a semiconductor storage (NAND flash memory) called SSD (Solid State Drive) in place of the HDD 141. There are a variety of methods for storing the digital information. However, it is desirable to have a larger capacity than the capacity of the main memory. Multiple interfaces such as SCSI (Small Computer System Interface), Fiber Channel and PCI-Express other than SATA can be used for the connection between the HDD 141 and the CPU 111.

The wireless NIC 151 (Network Interface Card) is a communication apparatus that transmits and receives communication packets across the network according to, e.g., IEEE802.11. The standard for use is not limited to IEEE802.11. A cellular communication oriented interface called LTE (Long Term Evolution) may be employed, and a cable interface called 100M Ethernet interface may also be used.

The external input unit 161 is a unit for inputting the information from outside. The external input unit 161 may be an input device for inputting human operations such as the keyboard, the mouse and a touch panel on the display 121. Alternatively, the external input unit 161 may also be an input device such as a temperature sensor for inputting the information given from other than persons. In the first embodiment, the external input is given to the CPU 111 according to the USB Standards. However, the connection to the CPU 111 may be established based on other standards (e.g., IEEE1394, RS-232C(Recommended Standard 232C), HDMI (High-Definition Multimedia Interface)) exclusive of the USB.

A possible configuration of the hardware configuration illustrated in FIG. 8 may be taken by way of a modification such that any one or more of the graphic processor 114, the USB controller 116, the bus controller 118 and the SATA host controller 119 exist outside the CPU. Furthermore, there can be considered a variety of modifications such as incorporating a part of functions of the wireless NIC 151 into the CPU.

In the first embodiment, the user interface processing unit 11 depicted in FIG. 2 is realized by the display 121, the external input unit 161 and the CPU 111. The rendering data generating unit 12 is realized by the CPU 111, especially by the graphic processor 114. The communication processing unit 17 is realized by the wireless NIC, the CPU core and the main memory 131. The data acquiring unit 14, the data pre-acquiring unit 16, the data storage 15 and the data extracting unit 13 are realized by the CPU cores 112, 113 and the main memory 131.

Herein, it is desirable that the data acquiring unit 14 and the data pre-acquiring unit 16 are executed by different CPU cores. It is also desirable that the data pre-acquiring unit 16 pre-acquires the data, during which the CPU core for executing the data acquiring unit 14 is set in a low power consumption status. This status being set, a further reduction in power consumption can be expected.

(Reference to Application Cache for HTML5)

The reference objects of a certain object (referrer object) have been acquired so far. However, a further reference object, i.e., a grandchild reference of the reference object may also be acquired. A description thereof will be made by taking an HTML5-based application cache for example.

The application cache designates a manifest file with a manifest attribute in <html> tag within the object. For instance, in the case of describing <html manifest=“test.appcache”>, “test.appcache” is a manifest file name, and this implies that a path name of the URL is the same as the path name of the URL of the object. Three sections can be described in the manifest file.

The URL(s) of zero or more objects can be described in a CACHE section, in which the objects described herein are stored in the data storage 15. Further, the data are treated always as the Fresh data during being stored irrespective of the values of “Age” and “max-age” specified by the HTTP protocol.

The URL(s) of zero or more objects can be described in a NETWORK section, in which the objects described herein are not stored in the data storage 15.

The URL(s) of zero or more objects can be described in a FALLBACK section, in which the objects described herein are to be stored in the data storage 15.

An operation in the case of using the application cache will hereinafter be described.

The data acquiring unit 14 transmits the data acquisition request to the Web server via the communication processing unit 17. The data pre-acquiring unit 16, upon receiving the response made by the Web server from the communication processing unit 17, queries the data extracting unit 13 about the reference objects contained therein. If this response contains the manifest file, the data pre-acquiring unit 16 queries the data storage 15 about the data related to the manifest file. If the response to the query indicates that the data are not stored or that the Stale data are stored, the data pre-acquiring unit 16 transmits the data acquisition request or the data acquisition request attached with the change acknowledgment to the Web server via the communication processing unit 17, and receives a response thereto.

If the data body of the manifest file can be acquired, i.e., if a response of “HTTP/1.1 304 Not Modified” is not received, the data pre-acquiring unit 16 hands the data of the acquired manifest file over to the data extracting unit 13 and makes the query about the objects contained therein. The data pre-acquiring unit 16, upon receiving the response to the query, transmits the data acquisition requests for the objects described in the CACHE section and the objects described in the FALLBACK section to the Web servers via the communication processing unit 17. At this time, it is desirable not to check whether the data are stored in the data storage 15 or not. This is because if there is a change in manifest file, it is prescribed to re-acquire the objects described therein in specifications of the application cache.

The data pre-acquiring unit 16, when finishing acquiring all of the necessary objects, transmits the first object to the data acquiring unit 14. Thereafter, if target objects (the reference objects, the grandchild objects, etc. of the first object) of the data acquisition request given from the data acquiring unit 14 have already been acquired by the data pre-acquiring unit 16, these objects are sent to the data acquiring unit 14 from the data pre-acquiring unit 16. These objects may also be sent at a point of time when receiving the request from the data acquiring unit 14. If there is any object that is not yet acquired, the data acquisition request for this object is transmitted to the Web server.

Thus, the data pre-acquiring unit 16 acquires the manifest file (i.e., the reference objects) contained in the object (the referrer object) and further acquires the objects (i.e., the grandchild objects) contained in the manifest file.

(Method Enabling Data Acquisition Request Attached with Change Acknowledgment not to be Issued)

In the first embodiment, if the data are retained in the Stale status, the data pre-acquiring unit 16 is in the process of transmitting the data acquisition request attached with the change acknowledgment. In the case of receiving “HTTP/1.1 304 Not Modified” as a response thereto, this data acquisition request attached with the change acknowledgment becomes useless resultantly. Such being the case, a further modified example will be demonstrated.

The Web server, on the occasion of transmitting the object data, simultaneously writes version information of the data of the reference object described therein. For example, a value of “etag” of the data retained by the Web server is written together with the URL of the reference object such as<img src=“http://img.toshiba.co.jp/logo.jpg” etag=“686897696a7c876b7e”> within the object data.

The data pre-acquiring unit 16, on the occasion of acquiring the reference object, compares a value of “etag” (of the reference object) written in the referrer object with a value of “etag” stored in the data storage 15. If these “etag” values are different from each other, the data pre-acquiring unit 16 transmits the data acquisition request for the reference object. Whereas if these “etag” values are the same, i.e., whereas if the object data stored in the data storage 15 is the same as the object data retained by the Web server, the data pre-acquiring unit 16 does not transmit the data acquisition request or the data acquisition request attached with the change acknowledgment.

The example of “etag” has been given as the version information of the object data retained by the Web server. However, as far as the terminal side can determine whether or not the object data retained by the Web server is the same as the object data retained by the terminal, the version information is not limited to “etag”. For instance, the data generation date/time, a hash value of the data, etc. can be used as the version information.

Moreover, the previous example has given the instance of describing the URL of the reference object and the version information thereof within the same tag. However, a variety of other modifications are also available. For example, the data containing the description of the version information can be described as another reference object.

Thus, the terminal acquires the version information of the reference object, thereby enabling the terminal to determine whether or not the data of the reference object retained by the terminal is the same as the data retained by the Web server. Hence, it follows that the terminal side may not transmit the data acquisition request attached with the change acknowledgment.

With this contrivance, load of the terminal can be decreased, thereby enabling the power consumption to be reduced. Further, it is feasible to reduce a required period of time till the data are displayed and therefore to moderate the irritating feeling of the user.

(Supplementary Explanation)

In the first embodiment, the data pre-acquiring unit 16 pre-acquires the reference object of the acquired object (referrer object). A variety of modifications other than the above can be applied to the method of determining the object that is pre-acquired.

For instance, the elements, unnecessary for displaying the referrer object, of the reference objects can be also set not to become the pre-acquiring targets. This corresponds to, e.g., the object specified by <a> tags.

While on the other hand, the object not undergoing the rendering in the window as in the case of the XML data can be also set as the pre-acquiring target. Namely, this is the case where a certain item of XML data is acquired from the server and a URL is described in this data. For instance, according to specifications of DLNA (Digital Living Network Alliance), a DMP (Digital Media Player) is configured to acquire the XML data containing a description of an attribute of a DMS (Digital Media Server) on the basis of SSDP (Simple Service Discovery Protocol) protocol, and further acquire another XML data containing a description of a more detailed attribute by use of the URL contained in the XML data. Herein, the XML data containing the description of the more detailed attribute is deemed to be a reference object and can be thereby set as a pre-acquiring target.

Moreover, it is supposed that when obtaining a certain item of data, another data other than this data becomes necessary for acquiring and it is possible to determine the other data based on some kind of knowledge and inference. In this case, the determined data is deemed to be the reference object and can be set as the pre-acquiring target.

It is desirable that the data pre-acquiring unit 16, after sending the pre-acquired data to the data acquiring unit 14, deletes this data. Further, if the data acquiring unit 14 does not send the data acquisition request for the pre-acquired data for, e.g., a certain fixed period of time, the data pre-acquiring unit 16 may send this data to the data storage 15. In this case, the data storage 15 gets stored with the data sent from the data pre-acquiring unit 16.

### Second Embodiment

A second embodiment will exemplify a case in which a sub-CPU executes a pre-fetch proxy operation on the terminal.

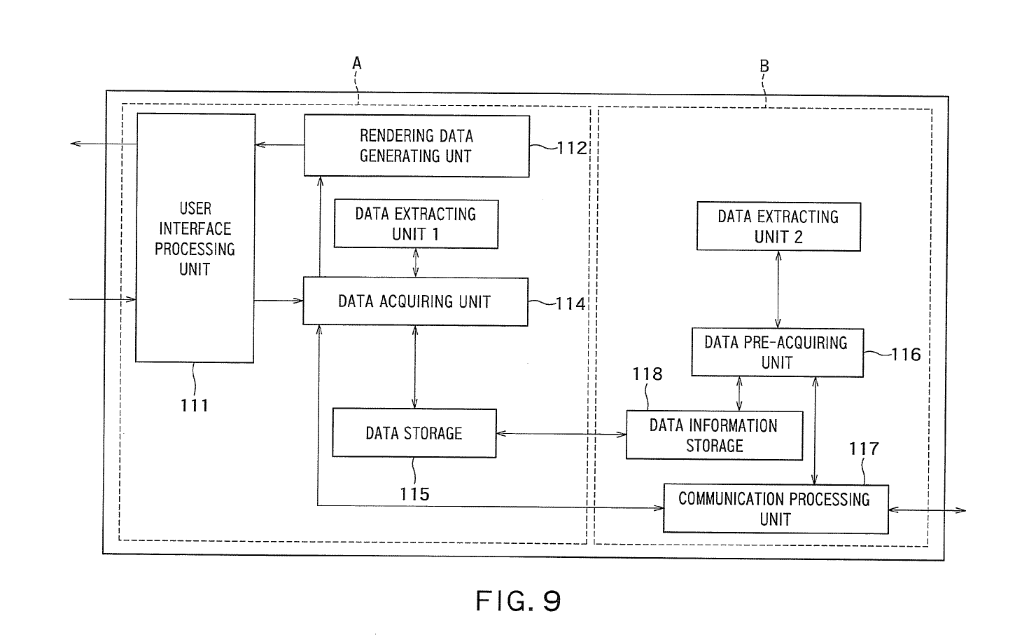

FIG. 9 depicts an example of a configuration of a terminal mounted with a communication apparatus according to the second embodiment. The architecture of the whole system including the terminal according to the second embodiment is the same as the architecture illustrated in FIG. 1 in the first embodiment.

In FIG. 9, the terminal includes a first configuration group A and a second configuration group B.

The first configuration group A includes a user interface processing unit 111, a rendering data generating unit 112, a data extracting unit 1, a data acquiring unit 114, and a data storage 115. The second configuration group B includes a data extracting unit 2, a data pre-acquiring unit 116, a data information storage 118 and a communication processing unit 117.

To start with, the first configuration group A will be described. The user interface processing unit 111, the rendering data generating unit 112, the data extracting unit 1 and the data storage 115 are the same as the user interface processing unit 11, the rendering data generating unit 12, the data extracting unit 13 and the data storage 15 in the first embodiment, respectively. However, in the second embodiment, the data storage 115 is not accessed from the data pre-acquiring unit.

The data acquiring unit 114 receives the URL of the object from the user interface processing unit 111, and transmits the data acquisition request for this object to the Web server via the communication processing unit 117. The data acquiring unit 114, upon receiving a response to this data acquisition request, requests the data extracting unit 1 to extract the reference object contained in this data, and receives the URL of the reference object extracted by the data extracting unit 1. The data acquiring unit 114 queries the data storage 115 about whether or not the data storage 115 is stored with the data of the reference object received from the data extracting unit 1.

The data acquiring unit 114, if the data storage 115 is stored with the Fresh data, acquires the data of the object from the data storage 115.

The data acquiring unit 114, whereas if the data storage 115 is stored with the Stale data, sends the data acquisition request or the data acquisition request attached with the change acknowledgment to the data pre-acquiring unit 116 via the communication processing unit 117.

The data acquiring unit 114, if the data storage 115 is not stored with the data, transmits the data acquisition request to the data pre-acquiring unit 116 via the communication processing unit 117.

Next, the second configuration group B will be described. The data extracting unit 2 is the same as the data extracting unit 13 in the first embodiment.

The data information storage 118 is stored with {URL, data generation date/time, Etag, Age, Max-age, data acquisition date/time} (which are generically termed “data information” in the present specification) as items of information on the object data stored in the data storage 115. This data information being used, it is possible to make a response to a query about whether the data storage 115 is stored with the data or not and also make a response, if stored with the data, about which data, the Fresh data or the Stale data, is stored.

It is desirable that the data information storage 118 acquires the data information from the data storage 115. It is desirable that the acquisition timing is set based on when any one of units in the first configuration group A operates. Given, for example, is timing of changing the data stored in the data storage 115. Further, the timing may not correspond to each time the data storage 115 changes the stored data but may correspond to when a predetermined number of changes occur in the data stored in the data storage 115. Alternatively, the timing may also be timing when a first change occurs in the data stored in the data storage 115 after a predetermined period of time has elapsed since the data information was acquired last time. A variety of other variations may also exist. Alternatively, the object data is received from the data pre-acquiring unit 116, and the data information stored in the data information storage 118 may be updated based on this received object data.

The data storage 115 is realized as, e.g., a function of a browser cache of a browser program, in which case the data information is extracted from the data storage 115 in a way that observes the information in the browser cache and can be transmitted to the data information storage 118. In this browser cache, e.g., a data information extracting function can be incorporated as software into the browser program. Alternatively, this data information extracting function can be realized as plug-in of the browser. Still alternatively, the data information extracting function can be also realized by way of a service of Daemon or OS in a way that observes the browser cache.

The data pre-acquiring unit 116, when receiving the acquisition data from the communication processing unit 117, requests the data extracting unit 2 to extract the reference objects contained in this data, and acquires the URLs of the reference objects as a response to this request. The data pre-acquiring unit 116 queries the data information storage 118 about whether the data of these objects are retained in the data storage 115 or not.

The data pre-acquiring unit 116, as a result of the query, if the Stale data are stored in the data storage 115, transmits the data acquisition request or the data acquisition request attached with the change acknowledgment to the Web servers via the communication processing unit 117.

The data pre-acquiring unit 116, as the result of the query, if the data are not stored in the data storage 115, transmits the data acquisition requests to the Web servers via the communication processing unit 117.

The data pre-acquiring unit 116, when finishing acquiring the data of the reference objects from the Web servers, sends the data of the referrer object to the data acquiring unit 114 via the communication processing unit 117. Further, the data pre-acquiring unit 116, when requested by the data acquiring unit 114 to acquire the reference objects via the communication processing unit 117, sends the already-acquired data of the reference objects to the data acquiring unit 114 via the communication processing unit 117.

The communication processing unit 117, when receiving the data acquisition request from the data acquiring unit 114, sets up the TCP connection of the destination port number 80 in the Web server of the destination, and transmits the data acquisition request according to the HTTP protocol. The communication processing unit 117, when receiving the data acquisition response from the Web server by way of the response to the request, hands this response over to the data pre-acquiring unit 116.

The communication processing unit 117, upon receiving the data acquisition request for the reference object from the data pre-acquiring unit 116, sets up the TCP connection of the destination port number 80 in the Web server of the destination, and transmits the data acquisition request, according to the HTTP protocol. The communication processing unit 117, when receiving the data acquisition response from the Web server by way of the response to the request, hands this response over to the data pre-acquiring unit 116.

The communication processing unit 117, when receiving the data acquisition response addressed to the data acquiring unit 114 from the data pre-acquiring unit 116, sends this data acquisition response to the data acquiring unit 114. The communication processing unit 117, upon receiving the data acquisition request addressed to the data pre-acquiring unit 116 from the data acquiring unit 114, sends this data acquisition request to the data pre-acquiring unit 116.

(Hardware Configuration)

In the second embodiment, it is desirable that the hardware components for operating the first configuration group A are differentiated from the hardware components for operating the second configuration group B. For example, such a mode can be exemplified that the first configuration group A is operated by the CPU 111 illustrated in FIG. 8, while the second configuration group B is operated by the wireless NIC 151. In this case, it is desirable that the wireless NIC 151 includes the CPU (unillustrated) and the OS.

Thus, the hardware is grouped, whereby only the second configuration group B can execute the majority of processes till the user interface processing unit 111 acquires the object (the referrer object) and the reference objects thereof since receiving the object acquisition event. All or a part of the hardware components executing the first configuration group A can, meanwhile, be set in a sleep status (a status disabling the components from processing) or in the low power consumption status (a slow processing status), and the reduction in power consumption can be expected. Moreover, the hardware components executing the second configuration group B are optimized corresponding to a should-be-implemented throughput and contents of the processes and also easily designed to attain the lower power consumption even during the processing.

Alternatively, in the case of including the plurality of CPUs, it is also feasible for the different CPUs to execute the first configuration group A and the second configuration group B.

Thus, the CPUs are grouped, whereby only the second configuration group B can execute the majority of processes till the user interface processing unit 111 acquires the object (the referrer object) and the reference objects thereof since receiving the object acquisition event. All or a part of the CPUs executing the first configuration group A can, meanwhile, be set in the sleep status (the status disabling the CPU from processing) or in the low power consumption status (the slow processing status), and the reduction in power consumption can be expected. Furthermore, the CPU executing the second configuration group B is optimized corresponding to the should-be-implemented throughput and the contents of the processes and also easily designed to attain the lower power consumption even during the processing. Typically, it is possible to make a design such as setting an operation clock count of the CPU executing the second configuration group B lower (than the clock count of the CPU executing the first configuration group A), realizing the CPU by transistors which exhibit less of leakage power or decreasing a quantity of the cache memories of the CPU.

Alternatively, the CPU, even when being a single unit, includes a plurality of CPU cores, in which case the first configuration group A and the second configuration group B can be also executed by the different CPU cores. With this contrivance, the different CPU core is thus used for every configuration group, whereby only the second configuration group B can execute the majority of processes till the user interface processing unit 111 acquires the object (the referrer object) and the reference objects thereof since receiving the object acquisition event. All or a part of the CPU cores executing the first configuration group A can, meanwhile, be set in the sleep status (the status disabling the CPU cores from processing) or in the low power consumption status (the slow processing status), and the reduction in power consumption can be expected. Further, the CPU core executing the second configuration group B is optimized corresponding to the should-be-implemented throughput and the contents of the processes and also easily designed to attain the lower power consumption even during the processing. Typically, it is possible to make a design such as setting an operation clock count of the CPU core executing the second configuration group B lower (than the clock count of the CPU core executing the first configuration group A), realizing the CPU core by transistors which and exhibit less of leakage power or decreasing a quantity of the cache memories of the CPU core.

Thus, according to the second embodiment, the data pre-acquiring unit 116 does not acquire the data of the object of which the Fresh data are stored in the data storage 115, and hence the reduction I power consumption can be expected. Especially in the case of having a large number of reference objects and in the case of requiring a considerable length of time for acquiring the object data due to a large delay on the network, an effect thereof can be more expected. Further, the data acquisition via the network is more time-consuming than acquiring the data from the data storage 115. Therefore, it is possible to decrease the time till the user interface processing unit 111 displays the rendering data since receiving the object acquisition event by not acquiring the data about the object data stored in the data storage 115 via the network. Hence, obviation of the irritating feeling of the user can be expected.

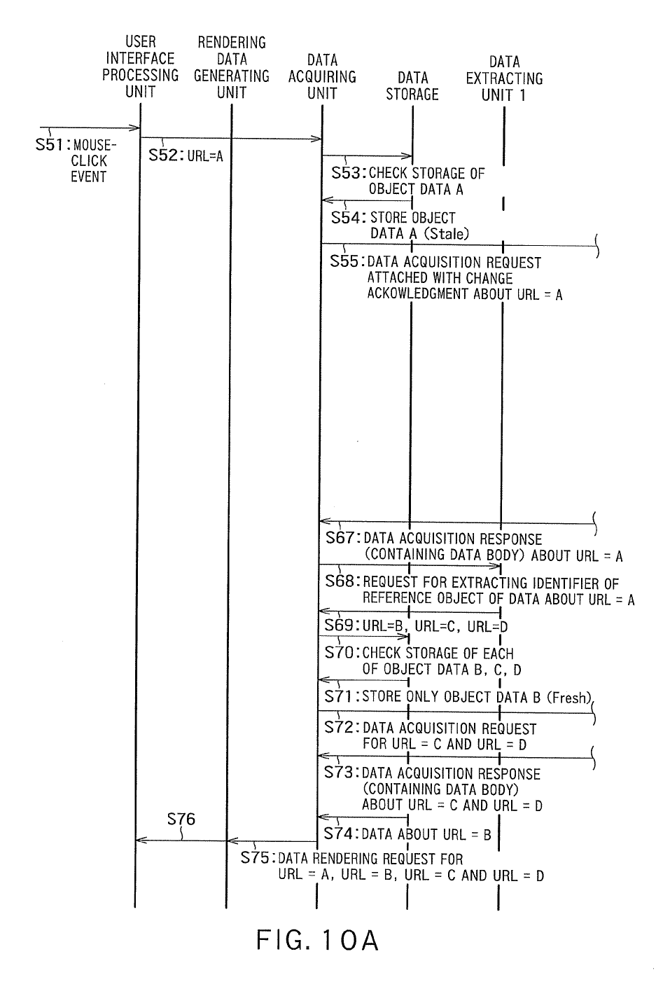

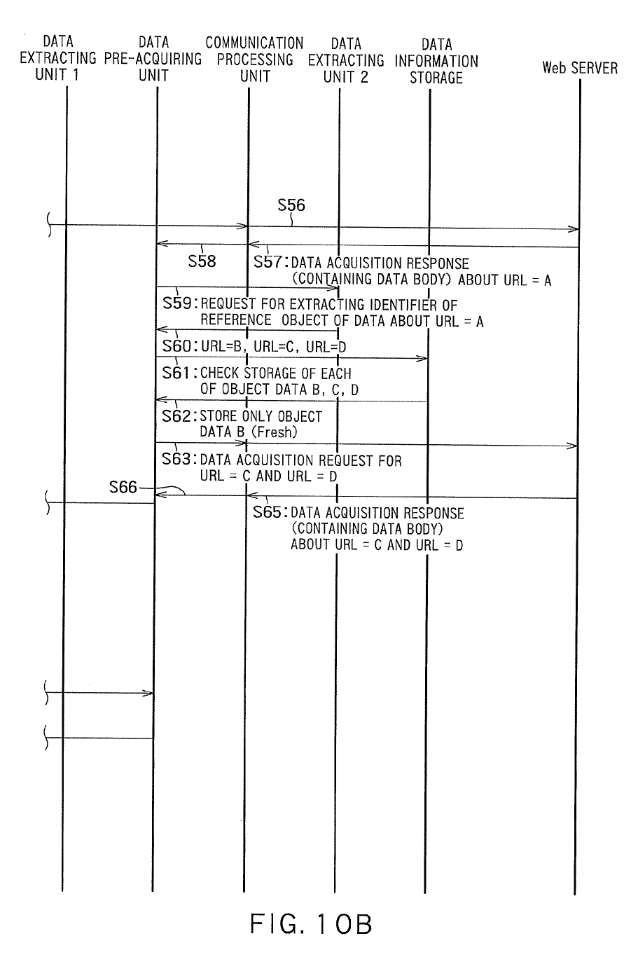

FIG. 10 illustrates a sequence diagram according to the second embodiment.

This operation example is given in the case of acquiring the data of URL=A (e.g., HTTP://www.toshiba.co.jp/index.html) upon a mouse-click event on the assumption that the identifiers of the reference objects of URL=A (the referrer object) are URL=B, URL=C and URL=D. Furthermore, it is also assumed that the data storage 115 has got already stored with data on URL=B in the Fresh status.

The mouse-click event is inputted to the user interface processing unit 111 (S51), and URL=A is sent to the data acquiring unit 114 (S52). The data acquiring unit 114 checks whether the data of URL=A is retained on the data storage 115 or not (S53), and acquires a response indicating that the data in the Stale status is retained (S54). The data acquiring unit 114 transmits the data acquisition request attached with the change acknowledgment with respect to URL=A to the Web server via the communication processing unit 117 (S55, S56). A data acquisition response (containing the data body) with respect to URL=A is sent back from the Web server and handed over to the data pre-acquiring unit 116 via the communication processing unit 117 (S57, S58).

The data pre-acquiring unit 116 requests the data extracting unit 2 to extract the identifiers of the reference objects of the data with respect to URL=A, with the result that the identifiers of URL=B, URL=C and URL=D are sent back (S59, S60). The data pre-acquiring unit 116 queries the data information storage 118 about whether the data information storage 118 retains the data of URL=B, URL=C and URL=D (S61). The data pre-acquiring unit 116 obtains a response indicating that the data storage 115 is stored with the Fresh data of URL=B but is stored with none of such data of URL=C and URL=D (S62). The data pre-acquiring unit 116 transmits the data acquisition requests for URL=C and URL=D to the Web servers via the communication processing unit 117 (S63, S64). Data acquisition responses (containing the data bodies) with respect to URL=C and URL=D are sent back from the Web servers and handed over to the data pre-acquiring unit 116 via the communication processing unit 117 (S65, S66).

The data pre-acquiring unit 116 sends a data acquisition response (containing the data body) with respect to URL=A to the data acquiring unit 114 (S67). The data acquiring unit 114 requests the data extracting unit 1 to extract the identifiers of the reference objects of the data with respect to URL=A (S68). The data extracting unit 1 extracts the identifiers of URL=B, URL=C and URL=D and sends the identifiers back to the data acquiring unit 114 (S69).

The data acquiring unit 114 queries the data storage 115 about whether or not the data storage 115 retains the data of URL=B, URL=C and URL=D (S70). The data acquiring unit 14 obtains a response indicating that the data storage 115 is stored with the Fresh data with respect to URL=B but is stored with none of such data with respect to URL=C and URL=D (S71). The data acquiring unit 114 sends the data acquisition requests for URL=C and URL=D to the data pre-acquiring unit 116 (S72). The data pre-acquiring unit 116 sends the data acquisition responses (containing the data bodies) with respect to URL=C and URL=D acquired in step S66 back to the data acquiring unit 114 (S73). Further, the data acquiring unit 114 acquires the data of URL=B from the data storage 115 (S74). The data acquiring unit 114 sends a rendering request of the data with respect to URL=A, URL=B, URL=C and URL=D to the rendering data generating unit 112 (S75). The rendering data generating unit 112 renders the data with respect to URL=A, URL=B, URL=C and URL=D, and hands the rendered data over to the user interface processing unit 111 (S76).

(Reduction in Storage Contents of Data Information Storage)

In the second embodiment discussed above, the data information storage 118 is stored with {URL, data generation date/time, Etag, Age, Max-age, data acquisition date/time} as items of information on the object data stored in the data storage 115. However, the data information storage 118 may be stored with only {URL} of the object data. With this contrivance, it is feasible to reduce a data size of the data stored in the data information storage 118 and also reduce a traffic quantity of the data transmitted and received between the data storage 115 and the data information storage 118. However, it can be determined whether to retain the data by storing only {URL} as the data information, and nevertheless it cannot be determined whether the retained data is the Fresh data or the Stale data. Therefore, the processing is carried out by deeming that all the data stored in the data storage 115 are the Stale data. A meaning of “the processing is carried out by deeming that all the data are the Stale data” is that as for the object data stored in the data storage 115, it follows that the data acquisition request of the object is transmitted in response to the request given from the data acquiring unit 114 even after the data pre-acquiring unit 116 has acquired the object. In an example of a sequence in FIG. 10, if the data storage 115 is stored with the data of the object of URL=B in the Stale status, the data acquiring unit 114 sends the data acquisition request for URL=B in addition to URL=C and URL=D in step S72. The communication processing unit 117 receiving this request transmits, because of the data pre-acquiring unit 116 not acquiring the object data of URL=B, the data acquisition request of the object of URL=B toward not the data pre-acquiring unit 116 but the Web server, and sends a response thereof to the data acquiring unit 114.

Herein, it is further desirable that the data information storage 118 is stored with only the data information on only the Fresh data stored in the data storage 115.

Moreover, {URL} is retained in a data structure called a Bloom Filter, thereby enabling the data size of the data stored in the data information storage 118 to be reduced. An algorithm of the Bloom Filter is briefly shown. The empty Bloom Filter is defined as a bit array of m-bits that are all set to “0”. Further, a k-number of hash functions are simultaneously defined, and each hash function maps a key value (i.e., URL) to any one of a m-number of array positions (bit positions). In a simple example, a value range of each hash function is “0” to “m”. Mappings of the respective URLs stored in the data information storage to the m-number of array positions are calculated and then summed up. Herein, the term “sum” connotes that if there exists even one URL mapped to the array position, this array position is set to “1” (i.e., a logical sum). The Bloom Filter is thus generated. When the data information storage 118 is queried about whether or not the data information storage 118 is stored with the data of the object of a certain URL, a k-number of hash values of the URL are calculated, and it is checked whether or not the array positions (bit positions) corresponding to the respective values are all “1” in the Bloom Filter. If all are “1”, it is determined that the data storage 115 is stored with this data. Whereas if not, it is determined that the data storage 115 is not stored with the data

In the case of using the Bloom Filter, such a possibility exists that it is mis-determined that the data storage 115 is stored with the data when not actually stored with the data. In this case, after the data pre-acquiring unit 116 has finished pre-acquiring process, it follows that the data acquisition request for the object is transmitted in response to the request given from the data acquiring unit 114. In the example of the sequence in FIG. 10, if it is mis-determined that the data storage 115 is stored with the data of the object of URL=B when not actually stored with the data, the data acquisition request for URL=B in addition to URL=C and URL=D is transmitted in step S72. The communication processing unit 117 receiving this request transmits, because of the data pre-acquiring unit 116 not acquiring the object data of URL=B, the data acquisition request of the object of URL=B toward not the data pre-acquiring unit 116 but the Web server, and sends a response from the Web server to the data acquiring unit 114.

### Modified Example 2

### Modification of Data Information Storage

The data information storage 118 can be also configured not to retain the data information but to query the data storage 115 about whether the data are retained or not.

Alternatively, if the data storage 115 is stored with the object data of URL=A in the Stale status, the data acquiring unit 114 can request the data extracting unit 1 to extract the reference objects of URL=A (referrer object) on the occasion of issuing the data acquisition request for the object of URL=A, query the data storage 115 about the data information with respect to the acquired reference objects of URL=B, URL=C and URL=D, and send the acquired data information to the data information storage 118 from the data storage 115. With this contrivance, the data information storage 118 may simply be stored with only the data information of the reference objects of the object data to be acquired. Hence, the storage area of the data information storage 118 can be reduced.

### Third Embodiment

A third embodiment will exemplify a case in which the pre-fetch proxy is provided on an apparatus different from the terminal.

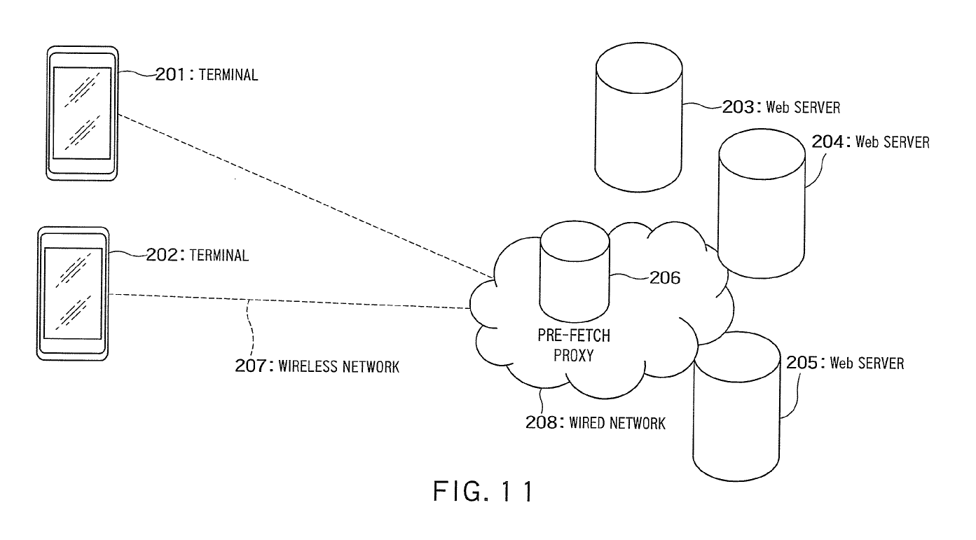

FIG. 11 illustrates architecture of the whole communication system according to the third embodiment. A difference from the first embodiment is that a pre-fetch proxy 206 is installed between terminals 201, 202 and Web servers 203, 204, 205. The pre-fetch proxy 206 may be installed in any one of a wired network 208 and a wireless network 207. The pre-fetch proxy 206 is capable simultaneously handling two or more terminals as well as handling one single terminal. In the illustrative example, the two terminals are depicted.

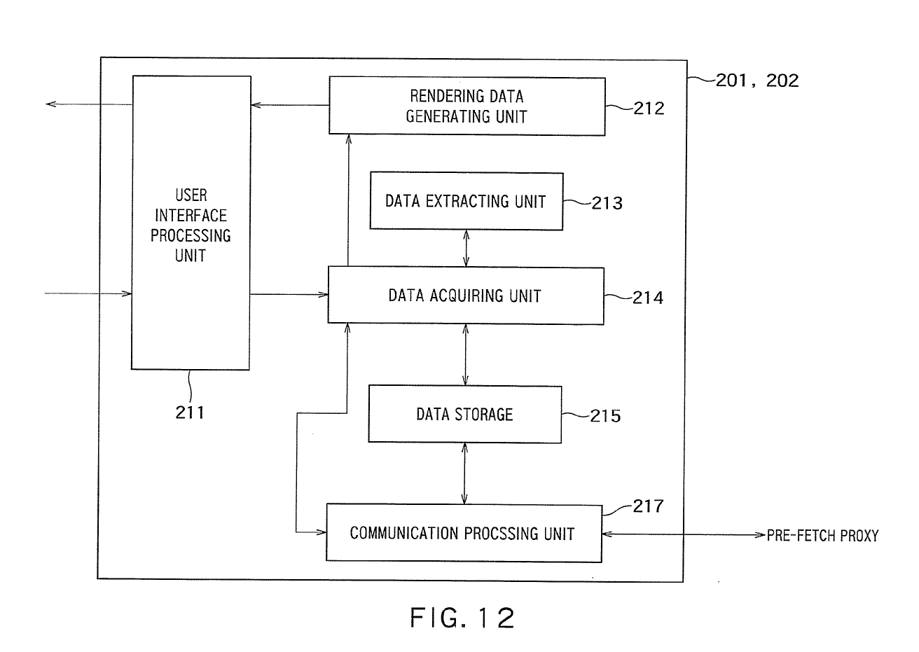

FIG. 12 illustrates an example of a configuration of the terminal according to the third embodiment. The present terminal includes a configuration corresponding to the first configuration group A in the second embodiment and the communication processing unit. To be specific, the present terminal includes a user interface processing unit 211, a rendering data generating unit 212, a data extracting unit 213, a data acquiring unit 214, a data storage 215 and a communication processing unit 217.

The user interface processing unit 211, the rendering data generating unit 212, the data extracting unit 213 and the data storage 215 are the same as the user interface processing unit 111, the rendering data generating unit 112, the data extracting unit 1 and the data storage 115 in the second embodiment. The communication processing unit 217 performs the communications with a communication processing unit 3127 of the pre-fetch proxy 206. Note that in the third embodiment, the information with a data information storage 218 of the pre-fetch proxy 206 is transmitted and received through the communication processing unit 217 because of via the communication network.

The data acquiring unit 214 receives the URL of the object from the user interface processing unit 211, and transmits the data acquisition request for this object to the Web server via the communication processing unit 217. The data acquiring unit 214, upon receiving a response to this data acquisition request, sends an extraction request for extracting the reference object contained in this data to the data extracting unit 213, and acquires the URL of the extracted reference object. The data acquiring unit 214 queries the data storage 215 about whether or not the data storage 215 is stored with the data of the acquired reference object.

The data acquiring unit 214, if the data storage 215 is stored with the Fresh data, acquires the data of the object from the data storage 215.

The data acquiring unit 214, whereas if the data storage 215 is stored with the Stale data, sends the data acquisition request or the data acquisition request attached with the change acknowledgment to the data pre-acquiring unit 216 of the pre-fetch proxy 206 via the communication processing unit 217.

The data acquiring unit 214, if the data storage 215 is not stored with the data, transmits the data acquisition request to the data pre-acquiring unit 216 of the pre-fetch proxy 206 via the communication processing unit 217.

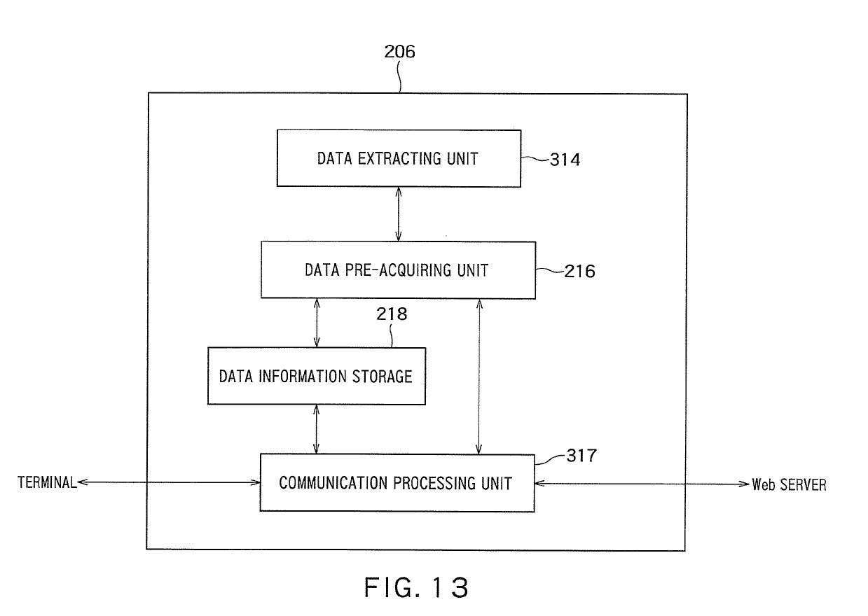

FIG. 13 illustrates an example of a configuration of the pre-fetch proxy 206 mounted with the communication apparatus according to the third embodiment. The pre-fetch proxy 206 includes the configuration corresponding to the second configuration group B in the second embodiment. To be specific, the pre-fetch proxy 206 includes a data extracting unit 314, the data pre-acquiring unit 216, the data information storage 218 and the communication processing unit 217.

The data extracting unit 314 is the same as the data extracting unit 2 in the second embodiment.

The data pre-acquiring unit 216, when receiving the acquisition data from the communication processing unit 317, requests the data extracting unit 314 to extract the reference objects contained in this data, and acquires the URLs of the reference objects as a response to this request. The data pre-acquiring unit 216 checks whether the data of these objects are retained in the data storage 115 of the terminal or not by querying the data information storage 218.

The data pre-acquiring unit 216, as a result of the query, if the Stale data are stored in the data storage 115, transmits the data acquisition request or the data acquisition request attached with the change acknowledgment to the Web servers via the communication processing unit 317.

The data pre-acquiring unit 216, as the result of the query, if the data are not stored in the data storage 115, transmits the data acquisition requests to the Web servers via the communication processing unit 317.

The data pre-acquiring unit 216, when finishing acquiring the data of the reference objects from the Web servers, sends the data of the referrer object to the data acquiring unit 214 via the communication processing unit 317. Further, the data pre-acquiring unit 216, when requested by the data acquiring unit 214 to acquire the reference objects via the communication processing unit 317, transmits the already-acquired data of the reference objects to the data acquiring unit 214 via the communication processing unit 317.

The data information storage 118 is stored with {URL, data generation date/time, Etag, Age, Max-age, data acquisition date/time} (which are generically termed “data information” in the present specification as described above) as items of information on the object data stored in the data storage 215. This data information being used, it is feasible to make a response to a query about whether the data storage 215 is stored with the data or not and also make a response, if stored with the data, about which data, the Fresh data or the Stale data, is stored.

It is desirable that the data information storage 218 receives the data information from the data storage 215 of the terminal via the communication processing unit 317. It is desirable that the reception timing is the same as the timing in the second embodiment. Given, for example, is timing of changing the data stored in the data storage 215 of the terminal. Further, the timing may not correspond to each time the data stored in the data storage 215 is changed but may correspond to when a predetermined number of changes occur in the stored data. Alternatively, the timing may also be first timing when the change occurs in the stored data after a predetermined period of time has elapsed since the data information was received last time. A variety of other variations can also exist. Alternatively, the object data is received from the data pre-acquiring unit 216, and the data information to be stored may be updated based on this received object data.

The communication processing unit 317, when receiving the data acquisition request from the data acquiring unit 214, sets up the TCP connection of the destination port number 80 in the Web server of the destination, and transmits the data acquisition request according to the HTTP protocol. The communication processing unit 317, when receiving the data acquisition response from the Web server by way of the response to the request, hands this response over to the data pre-acquiring unit 216. The communication processing unit 317, upon receiving the data acquisition request for the reference object from the data pre-acquiring unit 216, sets up the TCP connection of the destination port number 80 in the Web server of the destination, and transmits the data acquisition request according to the HTTP protocol. The communication processing unit 317, when receiving the data acquisition response from the Web server by way of the response to the request, hands this response over to the data pre-acquiring unit 216. The communication processing unit 317, when receiving the data acquisition response addressed to the data acquiring unit 214 from the data pre-acquiring unit 216, transmits this data acquisition response to the data acquiring unit 214. The communication processing unit 317, when receiving the data acquisition request addressed to the data pre-acquiring unit 216 from the data acquiring unit 214, sends this data acquisition request to the data pre-acquiring unit 216.

Herein, it is desirable that the data information stored in the data information storage 218 contains the identification information of each terminal, and the data information is managed on a terminal-by-terminal basis. For example, the data information storage 218 is stored with items of information such as {terminal identifier, URL, data generation date/time, Etag, Age, Max-age, data acquisition date/time}. Herein, any type of “terminal identifier” is available if capable uniquely identifying the terminal which handles the IP address and a MAC (Media Access Control) address of the terminal. It is desirable that the terminal identifier is contained also in the data acquisition request given from the data acquiring unit 214 of the terminal.

Alternatively, if a plurality of browsers run on one terminal, i.e., if the terminal includes two or more data storages, it is desirable that the data information storage 218 manages the data information per data storage. For instance, the data information storage 218 is stored with the items of information such as {terminal identifier, URL, data generation date/time, Etag, Age, Max-age, data acquisition date/time}. Herein, any type of identifier of the data storage can be applied if being the unique identifier among the respective terminals. To give a tangible example, a browser name and startup timing of the browser can be used. Herein, it is desirable that the terminal identifier and the browser identifier are contained also in the data acquisition request given from the data acquiring unit 214 of the terminal.

### Fourth Embodiment

A fourth embodiment will exemplify a multiple modified examples in terms of the hardware configuration of the terminal according to the second embodiment discussed above. The discussion will hereinafter be focused on differences from the second embodiment.

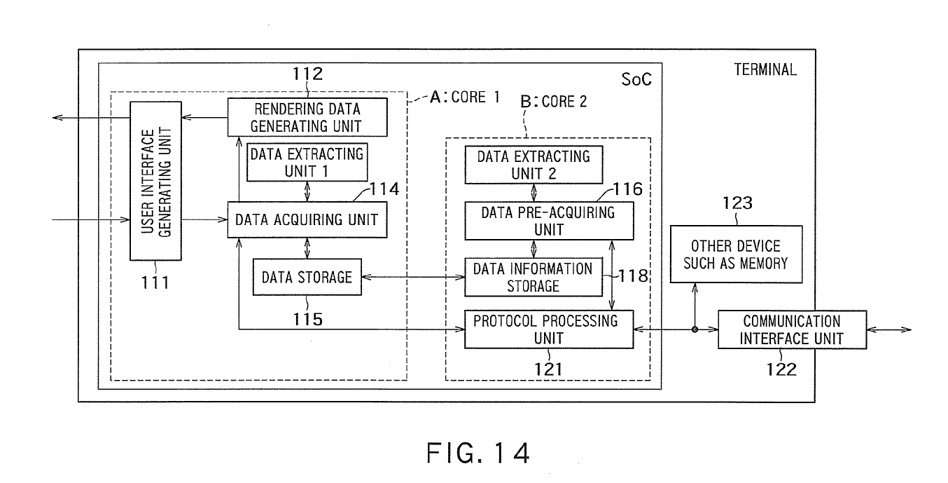

FIG. 14 illustrates an example 1 of the hardware configuration of the terminal according to the third embodiment. The same or corresponding components as or to those in FIG. 9 are marked with the same reference numerals and symbols, and the redundant explanations thereof are omitted (the same is applied to the following).

The communication processing unit 117 in FIG. 9 is divided into a protocol processing unit 121 and a communication interface unit 122, and the communication interface unit 122 is separated from the second configuration group B. The protocol processing unit 121 takes a charge of processes of the communication protocols such as TCP/IP and HTTP. The communication interface unit 122 takes a charge of processes of networks from a MAC layer (wireless network) or under. The first configuration group A is defined as a core 1, while the second configuration group B is defined as a core 2 (communication apparatus), in which the cores 1, 2 are configured on a semiconductor chip (semiconductor integrated circuit) as SoC (System-On-Chip). Other devices 123 such as a memory may also exist on a bus extending between the semiconductor chip and the communication interface unit.

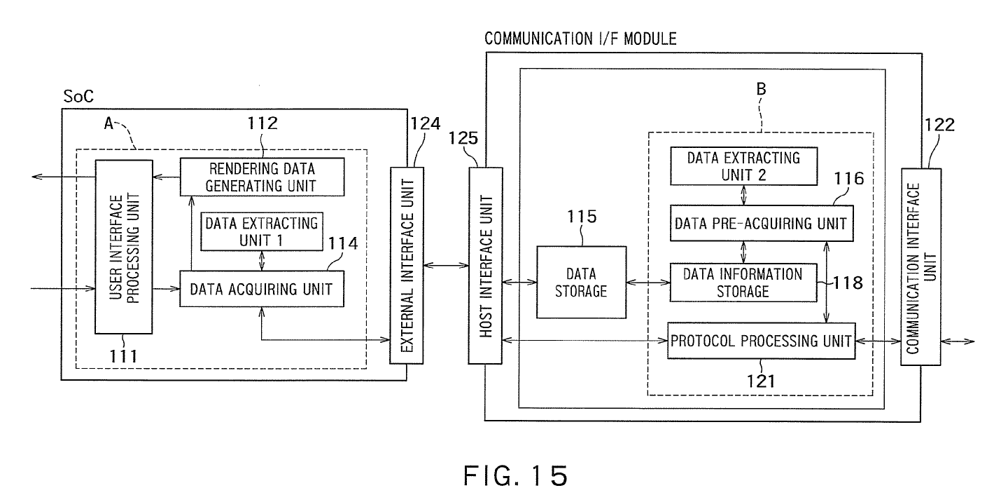

FIG. 15 illustrates an example 2 of the hardware configuration of the terminal according to the third embodiment.

The first configuration group A is configured on the chip, while the second configuration group B is configured on a communication I/F module (communication apparatus) such as the NIC. The data storage 115 is taken out of the first configuration group A and mounted on the communication I/F module. Exemplified, e.g., is a case where a memory device such as a NAND flash memory on the communication I/F module becomes a browser cache (data storage 115). A connection between the chip and the communication I/F module is established by an external interface unit 124 of the semiconductor chip and a host interface unit 125 of the communication I/F module via an internal bus.

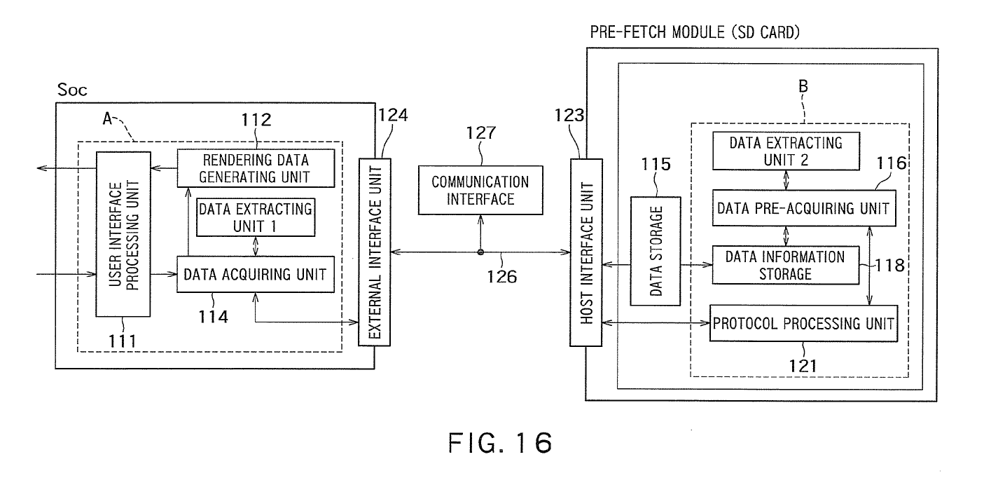

FIG. 16 illustrates an example 3 of the hardware configuration of the terminal according to the third embodiment.

The present example demonstrates a case in which the second configuration group B and the data storage 115 are mounted on a pre-fetch module (communication apparatus) such as an SD card. Similarly to the configuration in FIG. 15, the memory device such as the NAND flash memory becomes the browser cache (data storage 115). A communication interface 127 such as the NIC is connected onto a bus 126 extending between the semiconductor chip and the pre-fetch module.

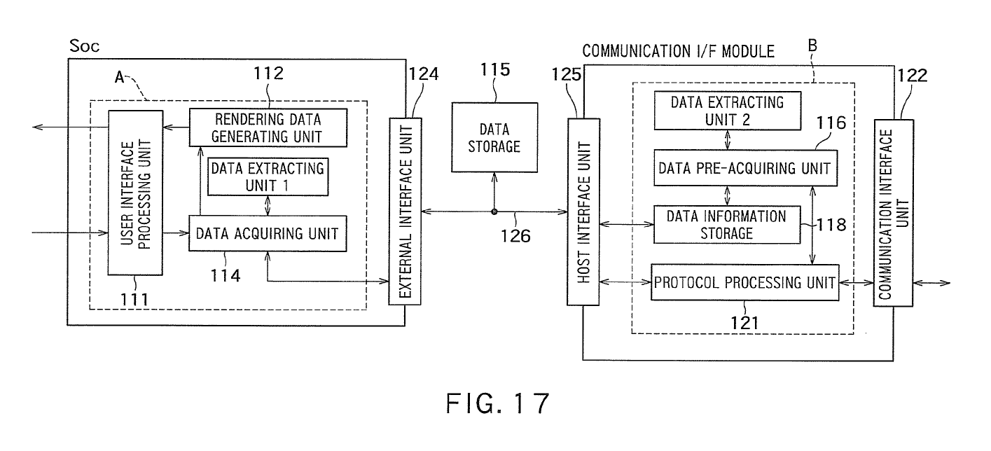

FIG. 17 illustrates an example 4 of the hardware configuration of the terminal according to the third embodiment.

A different point from the configuration in FIG. 15 is that the data storage 115 is disposed not on the communication I/F module but on the bus 126 extending between the semiconductor chip and the communication I/F module. The present example is of a configuration in such a case that a microcomputer (microprocessor, microcontroller: communication apparatus) on the communication I/F module implements a pre-fetch function, and the data are accumulated outside of the module. The communication I/F module is to be a module having a function of referring to the data storage 115 on the bus 126 via the host interface unit 125.

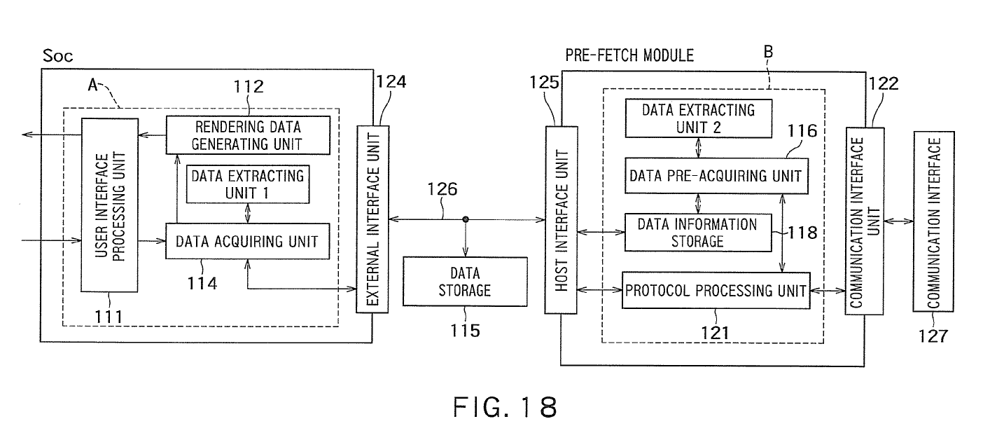

FIG. 18 illustrates an example 5 of the hardware configuration of the terminal according to the third embodiment.

In the present example, similarly to the configuration in FIG. 17, the data storage 115 is disposed on the bus 126, and the module (communication apparatus) as the chip mounted with the second configuration group B is disposed between the communication interface 127 (NIC etc.) and the semiconductor chip. This module refers to the data storage 115 on the bus 126 via the host interface unit 125 and accesses the communication interface 127 via the communication interface unit 122.

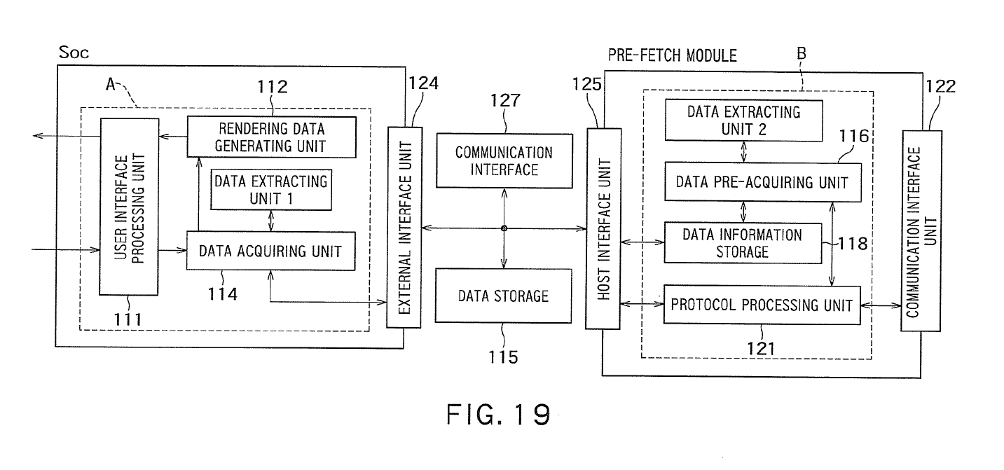

FIG. 19 illustrates an example 6 of the hardware configuration of the terminal according to the third embodiment.

A different point from the configuration in FIG. 18 is that the communication interface 127 is connected onto the bus 126. The configuration excluding this point is the same as the configuration in FIG. 18.

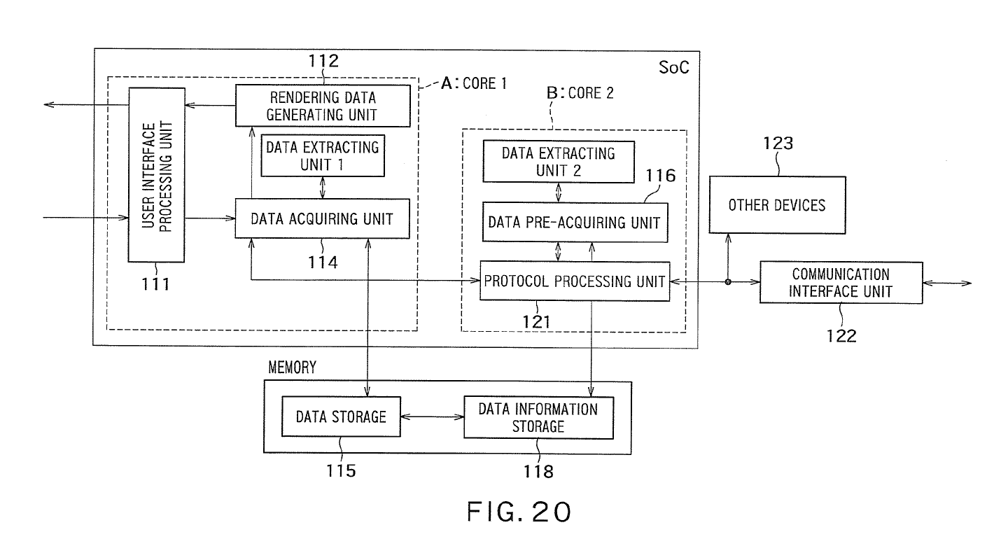

FIG. 20 illustrates an example 7 of the hardware configuration of the terminal according to the third embodiment.

A different point from the configuration in FIG. 14 is that the data storage 115 and the data information storage 118 are taken out of the cores 1, 2 and are configured on a memory device different from the semiconductor chip formed with the first configuration group A (core 1) and the second configuration group B (core 2). The memory device and the semiconductor chip are connected together via the bus.

The communication apparatus in each embodiment (a terminal, a chip, NIC, proxy, etc.) which has been heretofore described may also be realized using a general-purpose computer device as basic hardware. That is, each unit in the data preserving apparatus can be realized by causing a processor mounted in the above described computer device to execute a program. In this case, the communication apparatus may be realized by installing the above described program in the computer device beforehand or may be realized by storing the program in a storage medium such as a CD-ROM or distributing the above described program over a network and installing this program in the computer device as appropriate. Furthermore, the storages in the communication apparatus may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication apparatus comprising:
a first acquiring unit to acquire first data from a first acquisition destination upon receiving an acquisition request of the first data from a requester;
a determining unit to determine second data required for the requester by analyzing the first data acquired by the first acquiring unit and then determine whether the second data exists in a data storage accessible from the requester, the data storage being arranged inside or outside the communication apparatus; and
a second acquiring unit to acquire the second data from a second acquisition destination when it is determined the second data does not exist in the data storage.

2. The communication apparatus according to claim 1, wherein the determining unit detects data specified within the first data and determines the data as the second data.

3. The communication apparatus according to claim 1, wherein identification information of data is specified within the first data,
the determining unit detects the identification information in the first data and determines data identified by the identification information as the second data,
the determining unit determines, if the data identified by the identification information is stored in the data storage, whether there is such possibility that the data identified by the identification information in the data storage is different from data held by the second acquisition destination and identified by the identification information, and
the second acquiring unit acquires the second data from the second acquisition destination when it is determined there is such possibility by the determining unit.

4. The communication apparatus according to claim 1, wherein the first acquiring unit transmits the first data acquired from the first acquisition destination to the requester, and
the second acquiring unit transmits the second data acquired from the second acquisition destination to the requester upon receiving a request given from the requester.

5. The communication apparatus according to claim 4, wherein the first acquiring unit transmits the first data acquired from the first acquisition destination to the requester after the second acquiring unit has acquired the second data.

6. The communication apparatus according to claim 1, wherein the second acquiring unit stores the second data acquired from the second acquisition destination in the data storage.

7. The communication apparatus according to claim 1, wherein the determining unit reads information related to data held in the data storage from an information storage arranged inside or outside the communication apparatus and determines, based on the information read from the information storage, whether the second data exits in the data storage or not.

8. The communication apparatus according to claim 7, wherein the determining unit reads the information via an internal bus from the information storage.

9. The communication apparatus according to claim 7, wherein the information storage is provided inside the communication apparatus.

10. The communication apparatus according to claim 9, wherein the data storage is provided inside the communication apparatus.

11. The communication apparatus according to claim 1, wherein the determining unit, after the first acquiring unit has acquired the first data, queries the requester to determine whether the second data exists in the data storage.

12. The communication apparatus according to claim 1, further comprising a receiving unit to receive an acquisition request of the first data from the requester via an internal bus, and the first acquiring unit carries out acquiring the first data when the receiving unit receives the acquisition request of the first data.

13. The communication apparatus according to claim 1, wherein the communication apparatus is a network interface card or a memory card.

14. The communication apparatus according to claim 1, wherein the requester, the first acquiring unit, the determining unit and the second acquiring unit are configured on a semiconductor integrated circuit.

15. The communication apparatus according to claim 1, further comprising the requester,
wherein the requester is configured to transition to a low power consumption status during at least a part of period during which the second acquiring unit performs an operation of acquiring the second data.

16. The communication apparatus according to claim 1, further comprising a receiving unit to receive an acquisition request of the first data from the requester via a wireless network or a wired network.

17. A communication method performed in a communication apparatus, comprising:
acquiring first data from a first acquisition destination upon receiving an acquisition request of the first data from a requester;
determining second data required for the requester by analyzing the first data acquired and then determining whether the second data exists in a data storage accessible from the requester, the data storage being arranged inside or outside the communication apparatus; and
acquiring the second data from a second acquisition destination when it is determined the second data does not exist in the data storage.

18. A non-transitory computer readable medium having instructions stored therein which causes, when executed by a processor, the processor to execute processing of steps comprising:
acquiring first data from a first acquisition destination upon receiving an acquisition request of the first data from a requester;
determining second data required for the requester by analyzing the first data acquired and then determining whether the second data exists in a data storage accessible from the requester, the data storage being arranged inside or outside the communication apparatus; and
acquiring the second data from a second acquisition destination when it is determined the second data does not exist in the data storage.
